(19) United States
(12) Patent Application Publication
(10) Pub. No.: US 2026/0142744 A1
(43) Pub. Date: May 21, 2026

(54) Methods and Systems For Monitoring Upstream Communication Channels in a Cable Service Network

(71) Applicant: Charter Communications Operating, LLC, St. Louis, MO (US)

(72) Inventor: Vinod DANI, Littleton, CO (US)

(21) Appl. No.: 18/950,359

(22) Filed: Nov. 18, 2024

(51) Int. Cl. H04L 1/00; H04L 1/22; H04L 12/28; H04L 47/26

(52) U.S. Cl. CPC H04L 1/0002; H04L 1/0009; H04L 1/22; H04L 47/26; H04L 12/2801

(57) ABSTRACT

Various embodiments include methods and devices that enable cable modems or network elements to monitor upstream channels for communications between cable modems and the Cable Modem Termination System (CMTS) and prompt the CMTS to impair an upstream channel with an error rate exceeding a threshold. In some embodiments, cable modems or a network element may periodically request Forward Error Correction (FEC) data from the CMTS and identify whether an upstream channel should be impaired based on predefined error rate thresholds. If an upstream channel is found to have error rates exceeding an acceptable error rate threshold, the cable modem or network element may signal the CMTS to impair that channel. Additionally, the cable modem or network element may continue to monitor impaired upstream channels and signal the CMTS to recover channels that exhibit error rates less than corresponding thresholds.

### BACKGROUND

In cable service network systems, reliable data transmission between a cable modem and a cable modem termination system (CMTS) is facilitated by the use of Forward Error Correction (FEC) techniques. FEC allows the detection and correction of transmission errors without requiring retransmission of the original data. To achieve this, transmitted data is divided into units called codewords, which include both data bits representing the actual information being sent and redundancy bits generated using specific algorithms. These redundancy bits enable the receiver to detect and correct errors in the data bits. Codewords may ensure reliable communication over potentially noisy or interference-prone upstream channels in a cable system network. In instances in which errors occur during transmission, the FEC mechanism uses the redundancy bits to correct errors within the codeword as long as the number of errors falls within the correction capability of the chosen FEC scheme. In instances in which the number of errors exceeds the correction capability of the chosen FEC scheme, the communication channel may be impaired and not useable for communications, at least until the error rate in the communication channel improves.

### SUMMARY

Various aspects include methods performed by a cable modem for monitoring error rates in upstream communication channels communicating with a Cable Modem Termination System (CMTS). Various aspects may include a cable modem periodically sending a request to the CMTS for forward error correction (FEC) data for communications in assigned upstream channels; analyzing, by the cable modem, the FEC data to determine whether an error rate in any assigned upstream channel exceeds a predefined error rate threshold corresponding to a type of modulation used in a respective assigned upstream channel; and sending, by the cable modem, a message to the CMTS identifying an upstream channel that should be impaired or lowered in modulation in response to determining that the error rate of an identified upstream channel equals or exceeds the corresponding predefined error rate threshold. In some aspects, the message sent by the cable modem to the CMTS identifying the upstream channel that should be impaired or lowered in modulation is a traffic management message that includes an identifier of the upstream channel and an identifier of an impairment event type. Some aspects may further include receiving by the cable modem from the CMTS a dynamic bonding change request (DBC-REQ) message indicating that the identified upstream channel is impaired or lowered in modulation; and sending, by the cable modem, a message to the CMTS acknowledging that the identified upstream channel is impaired; and suspending use of the identified upstream channel in transmissions to the CMTS.

Some aspects may further include continuing to send requests from the cable modem to the CMTS for FEC data from the CMTS for an assigned upstream channel that is impaired by the CMTS; analyzing, by the cable modem, FEC data received from the CMTS for the assigned upstream channel that is impaired by the CMTS to determine whether the error rate in that assigned upstream channel has decreased below the predefined error rate threshold for the type of modulation used in that upstream channel; and sending, by the cable modem, a message to the CMTS to recover the impaired or use higher modulation for assigned upstream channel in response to determining that the error rate is less than the predefined error rate threshold for the type of modulation used in that assigned channel. In some aspects, the message sent by the cable modem to the CMTS to recover the impaired assigned upstream channel may be a traffic management message that includes an identifier of the impaired assigned upstream channel and an identifier of a recovery event type. Some aspects may further include receiving by the cable modem from the CMTS a dynamic bonding change request (DBC-REQ) message indicating that the identified assigned upstream channel is available for use or raising channel modulation; sending, by the cable modem, a DBC response (DBC-RSP) message to the CMTS acknowledging that the identified assigned upstream channel is no longer impaired or that the modulation is raised; and resuming use of the identified assigned upstream channel in transmissions to the CMTS. In some aspects, the requests sent by the cable modem to the CMTS for FEC data are management traffic messages that include a channel identifier (ID) and a type of data requested.

Some aspects may further include receiving, by the cable modem, a bonding change request (BCR) message from the CMTS indicating an updated status of the identified assigned upstream channel.

Some aspects may further include selecting from memory of the cable modem the predetermined error threshold for the type of modulation used in each upstream channel from a plurality of predetermined thresholds corresponding to types of modulation used in upstream channels.

Further aspects include methods that may be performed by a CMTS for receiving messages from a cable modem regarding upstream channel management. Such aspects may include receiving from a cable modem a message requesting forward error correction (FEC) data for an upstream channel identified in the message; providing FEC data for the identified upstream channel to the cable modem; receiving from the cable modem a message identifying an upstream channel that should be impaired or lowered in modulation; and placing the identified upstream channel in an impaired state or lowering modulation of the channel and sending a dynamic bonding change (DBC) request (DBC-REQ) message to the cable modem changing the allocation or the modulation of the identified upstream channel for use by the cable modem in response to receiving the message indicating that the identified upstream channel should be impaired or lowered in modulation.

Some aspects may further include receiving from the cable modem a request to provide FEC data for an impaired upstream channel specified in the request; providing FEC data for the identified upstream channel to the requesting cable modem; receiving from the cable modem a message indicating that the identified upstream channel can be recovered or use a higher modulation; and placing the identified upstream channel in an active state and sending a DBC-REQ message to the cable modem reallocating or raising modulation of the identified upstream channel for use by the cable modem in response to receiving the message indicating that the identified upstream channel can be recovered or use a higher modulation.

Further aspects include methods performed by a network element separate from a CMTS for monitoring upstream channels for communications between the CMTS and cable modems. Such aspects may include monitoring, by the network element, forward error correction (FEC) data within communications in upstream channels between the CMTS and the cable modems; analyzing, by the network element, the FEC data to determine whether an error rate in any upstream channel exceeds a predefined error threshold corresponding to a type of modulation used in a respective upstream channel; sending, by the network element, a message to the CMTS identifying an upstream channel that should be impaired or use lower modulation in response to determining that the error rate of the identified upstream channel equals or exceeds the predefined error threshold for the type of modulation used in the identified upstream channel. In some aspects, the message sent by the network element to the CMTS identifying an upstream channel that should be impaired or use lower modulation includes an identifier of the upstream channel and an identifier of an impairment event type.

Some aspects may further include continuing to monitor, by the network element, FEC data within communications in upstream channels impaired by the CMTS; analyzing, by the network element, FEC data for the upstream channels impaired or using lowered modulation by the CMTS to determine whether the error rate in each upstream channel has decreased below the corresponding predefined error rate threshold; and sending, by the network element, a message to the CMTS to recover an impaired upstream channel or use higher modulation for upstream channel in response to determining that the error rate in that upstream channel is less than the predefined error rate thresholds. In some aspects, the message sent by the network element to the CMTS to recover the impaired upstream channel is a traffic management message that includes an identifier of the impaired upstream channel and an identifier of a recovery event type.

Some aspects may further include selecting the predetermined error threshold from memory of the network element each monitored upstream channel based on a modulation of the upstream channel from a plurality of predetermined thresholds corresponding to types of modulation used in upstream channels.

Further aspects include methods that may be performed by a CMTS for receiving messages from a cable modem regarding upstream channel management. Such aspects may include receiving from an external system a message indicating that a communication channel identified in the message should be impaired or lowered in modulation; in response to receiving the message from the external system, placing the identified upstream channel in an impaired state and sending a dynamic bonding change (DBC) request (DBC-REQ) message to a cable modem using the identified upstream channel, the DBC request indicating that the upstream channel is impaired or lowering modulation of the channel; and receiving a DBC response (DBC-RSP) from the cable modem acknowledging impairment or lowering of modulation of the identified upstream channel. Some aspects may further include receiving from the external system a message indicating that the identified upstream channel can be recovered or higher modulation can be used; placing the specified upstream channel in an active state or raising the modulation of the channel and sending a DBC-REQ message to the cable modem reallocating the identified upstream channel for upstream communication use by the cable modem in response to receiving the message indicating that the specified upstream channel can be recovered; and receiving a DBC response (DBC-RSP) from the cable modem acknowledging availability or raised modulation of the identified upstream channel.

Further aspects may include a cable modem including a processor or processors configured to perform operations of any of the aspects described above. Further aspects may include a network element computing device, such as a server, including a processor or processors configured to perform operations of any of the aspects described above. Further aspects include a non-transitory processor-readable medium on which are stored processor-executable instructions configured to cause a processing system to perform operations of any of the aspects described above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIGS. 1A and 1B are block diagrams illustrating networks suitable for implementing some embodiments.

FIG. 2 is a message flow diagram showing sequences of messages involved in an embodiment in which the cable modem monitors error rates of upstream communication channels with the CMTS.

FIG. 3 is a message flow diagram showing sequences of messages involved in an embodiment in which an external system monitors error rates of upstream communication channels between the CMTS and cable modems.

FIG. 4A is a block diagram of an example cable modem coupled to the CMTS illustrating hardware and functional modules suitable for implementing some embodiments.

FIG. 4B is a block diagram of an example external system computing device coupled to the CMTS illustrating hardware and functional modules suitable for implementing some embodiments.

FIGS. 5A and 5B are process flow diagrams illustrating a method of a cable modem monitoring and managing upstream communication channels according to some embodiments.

FIG. 6 is a process flow diagram illustrating a method of an external system monitoring and managing communication channels between the CMTS and cable modems according to some embodiments.

FIG. 7 is a process flow diagram illustrating a method of a CMTS for responding to messages from a cable modems for monitoring and managing upstream communication channels according to some embodiments.

FIG. 8 is a process flow diagram illustrating a method of a CMTS for responding to messages from an external system for monitoring and managing cable modem upstream communication channels according to some embodiments.

FIG. 9 is a component diagram of an example cable modem suitable for implementing various embodiments.

FIG. 10 is a component diagram of an example server suitable for implementing various embodiments.

### DETAILED DESCRIPTION

The various embodiments will be described in detail with reference to the accompanying drawings. The same reference numbers will be used throughout the drawings to refer to the same or like parts wherever possible. References to particular examples and implementations are for illustrative purposes and are not intended to limit the scope of the invention or the claims.

In overview, various embodiments include methods and computing devices configured to implement the methods for enabling cable modems or an external system to inform the CMTS when an upstream channel is exhibiting unacceptable uncorrectable error rates to prompt the CMTS to impair such channels.

In a first embodiment, a cable modem is configured to monitor upstream channel usability and in instances in which uncorrectable error rates exceed a threshold of acceptability, the cable modem requests the CMTS to designate that upstream channel in an impaired state instead of waiting for the CMTS to make that designation. Since the cable modem is already aware of its data transmissions, during data transmission periods, the cable modem may periodically request from the CMTS the FEC codewords data for each upstream channel on which it is transmitting. In instances in which the cable modem finds that an unacceptable rate of uncorrectable codewords are occurring on an upstream channel but communication grants are still being received on that channel from the CMTS, the cable modem may send a message to the CMTS requesting that the upstream channel be changed to an impaired state to prevent further use of that channel. Upon receiving this request from the cable modem, the CMTS may use the Dynamic Bonding Change (DBC) process to impair the upstream channel or otherwise change the upstream channel configuration assigned to the cable modem. Recovery of an impaired upstream channel exhibiting acceptable uncorrectable error rates may be performed by the CMTS per current protocols. Alternatively, the cable modem may periodically request FEC data for the impaired upstream channel and send a message to the CMTS requesting or suggesting recovery of an impaired upstream channel exhibiting acceptable uncorrectable error rates.

In a second embodiment, an external system may monitor error rates in upstream channels bonded to cable modems communicating with the CMTS and instruct the CMTS to impair an upstream channel exhibiting unacceptable uncorrectable error rates. The external system may obtain the FEC data for all connected cable modems and all upstream channels used by these cable modems on a regular interval. The external system may also obtain data from the CMTS related to grants issued from CMTS to its connected cable modems. The external system may keep monitoring the uncorrectable error rates of each upstream channel of each cable modem. In instances in which the external system finds that there are unacceptable uncorrectable error rates in an upstream channel and the CMTS continues to grant communication windows on that upstream channel, the external system may instruct the CMTS to impair or otherwise remove this channel from the upstream channels assigned to the associated cable modem. In response, the CMTS may use the DBC process to convey this information to cable modem and stop assigning grants on the identified upstream channel. Recovery of impaired upstream channels with improving error rates may be performed by the CMTS per current protocols. Alternatively, the external system may monitor FEC data or other error rate statistics and inform the CMTS when an impaired upstream channel for a given cable modem may be removed from the impaired list or otherwise recovered.

The terms “component,” “module,” “operation,” and the like are used in this application to refer to various computer-related entities tasked with specific operational functions. These may include hardware components, software programs, combinations thereof, or processes in execution. For example, a component or a module may be a software application made of multiple operations that execute on a computing device, a processor executing instructions, a thread of a program, or the device itself. Components and modules may operate individually within a single processing environment or may be distributed across multiple processing units to utilize the capabilities of multicore or parallel computing architectures. Components may execute instructions (which may be referred to as modules) stored on different types of non-transitory computer-readable media and communicate via local or remote process interactions, inter-process communications, electronic signaling, data packet transfers, and other established protocols for data exchange and function coordination.

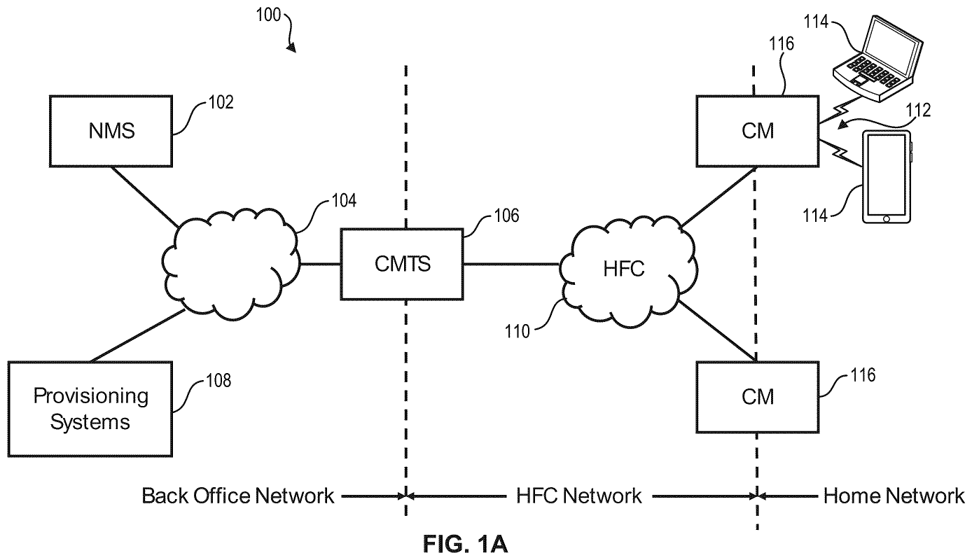

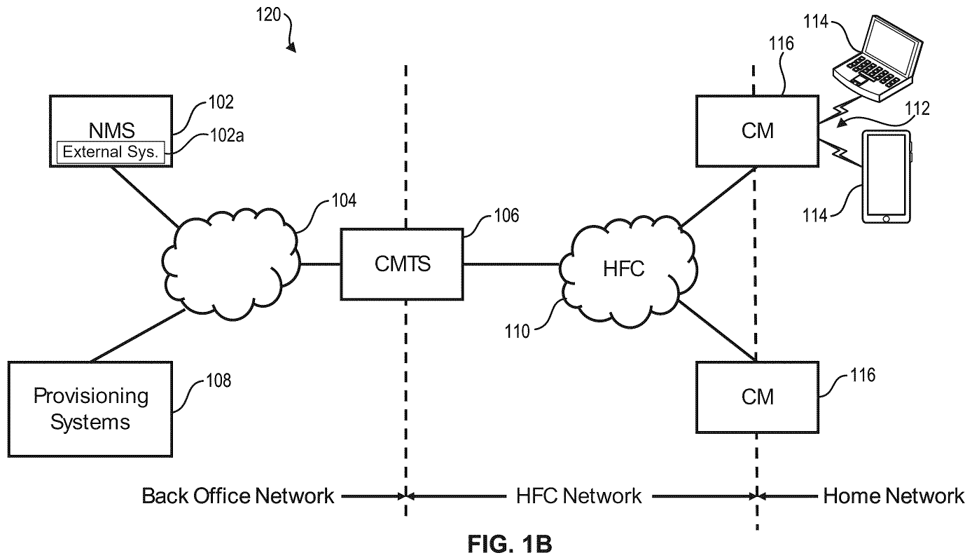

The term “network element” is used herein to refer to a computing device or functionality module within a computing device within a cable service network that is separate from the CMTS and cable modems. In particular, the term network element is used to refer to a system external to the CMTS and cable modems that performs operations of some embodiments described herein. As explained in more detail with reference to FIG. 1B, a network element that performs operations of some embodiments may be a separate computing device (e.g., a server) located within the cable service network (e.g., within a multiple system operator (MSO) premises, or additional functionality or functional module within another network element, such as a Differentiated Services Code Point (DSCP). The network element performing operations of some embodiments is sometimes referred to herein as an “external system” to emphasize that such a network element is separate from the CMTS and cable modems.

The term “processing system” is used herein to refer to one or more processors, including multi-core processors, that are organized and configured to perform various computing functions, such as performing functions of a server. Various embodiment methods may be implemented in one or more of multiple processors within a processing system as described herein.

The Data Over Cable Service Interface Specification (DOCSIS) is a telecommunications standard used primarily for delivering high-speed data services, such as internet and file delivery, over cable television systems. DOCSIS enables the addition of high-bandwidth data transfer to an existing cable TV (CATV) system, for example, which is particularly useful for broadband internet and file sharing applications. The DOCSIS standard defines modulation, channel access methods, and security protocols to facilitate fast and secure data delivery through coaxial cable networks. DOCSIS supports multiple versions, each offering improvements in speed, efficiency, and capabilities, thereby ensuring the standard can meet evolving technological demands and enhance user experiences in data-intensive applications.

In cable modem communications, communication channels assigned to a cable modem by the CMTS are referred to as bonded channels. Assigned or bonded channels are the aggregation of multiple upstream or downstream communication channels to create a single, higher-capacity logical link between the cable modem and the CMTS. This technique, introduced in DOCSIS 3.0, enables the simultaneous use of several physical channels, thereby increasing the total bandwidth available for data transmission. Bonded channels allow for more efficient utilization of the network's spectrum and improved data throughput for subscribers.

The CMTS may specify different modulation schemes for each bonded channel based on the signal quality and bandwidth requirements. For upstream communications, the modulation schemes range from QPSK (Quadrature Phase-Shift Keying), used for robust low-bandwidth communication, to higher-order schemes such as 16-QAM (Quadrature Amplitude Modulation), 64-QAM, 128-QAM, and 256-QAM, which provide greater data capacity but require better signal-to-noise ratios. In DOCSIS 3.1 networks, OFDMA (Orthogonal Frequency-Division Multiple Access) modulation may be used, which subdivides the channel into multiple subcarriers that can each be modulated with different QAM orders, supporting modulations as high as 4096-QAM for optimal high-capacity transmissions. The CMTS dynamically assigns modulation profiles for each bonded upstream channel based on current network conditions to optimize upstream performance.

During the initialization of communications between a cable modem and the Cable Modem Termination System (CMTS) in a DOCSIS-compliant system, the cable modem requests upstream communication channels through a series of messages. This process begins with the cable modem transmitting a Ranging Request (RNG-REQ) message, which prompts the CMTS to assess the modem's transmission characteristics. In response, the cable modem sends a Ranging Response (RNG-RSP) message identifying the communication capabilities of the cable modem.

The CMTS uses this information to assign multiple upstream channels based on the capabilities reported by cable modem and the support available in the CMTS. In assigning upstream channels to a cable modem, the CMTS specifies the initial transmission parameters for the cable modem, such as power levels, timing offsets, and frequency adjustments. Following this, the cable modem sends a DHCP Request, and as part of the configuration process, the CMTS identifies the number and type of upstream channels that the cable modem can use for data transmission. These channels are referred to as “bonded” for upstream communications. The type of upstream channels may include information about each channel's modulation type, such as QPSK or QAM, and bandwidth availability. This information is conveyed to the cable modem through the Upstream Channel Descriptor (UCD) message, which includes the technical parameters of each channel, such as modulation profiles and symbol rates.

Upon receiving the bonded channel configuration information, the cable modem configures its upstream transmission settings in accordance with the identified upstream channels and modulation profiles. The modem then sends a Registration Request (REG-REQ) message, finalizing its configuration and preparing for regular upstream data transmission. The CMTS responds with a Registration Response (REG-RSP) message, completing the initialization process and granting the modem permission to begin upstream communications using the assigned channels. The cable modem may respond with an acknowledgement message.

In DOCSIS-compliant cable communication systems, traffic management between the cable modem and the CMTS is facilitated through a set of Dynamic Service Flow (DSF) messages that allow for dynamic adjustment of service flows to manage traffic efficiently. A key message in this set is the Dynamic Service Addition (DSA) message, which enables the cable modem to request the establishment of a new service flow with specific parameters, such as bandwidth allocation, priority levels, and Quality of Service (QoS) guarantees. This allows the cable modem to manage different types of traffic, such as voice, video, and data, ensuring that higher-priority traffic receives appropriate resources.

Another message in this set is the Dynamic Service Change (DSC) message that allows the cable modem to modify an existing service flow, adjusting traffic parameters as needed to accommodate changing network conditions or traffic demands. A further Dynamic Service Deletion (DSD) message enables the cable modem to request the removal of a service flow that is no longer required. These traffic management messages provide the cable modem with the capability to dynamically adjust service flows in real-time, optimizing network performance and ensuring that critical traffic is prioritized.

In cable modem systems, reliable data transmission between a cable modem and the CMTS is facilitated using Forward Error Correction (FEC) techniques. FEC allows the detection and correction of transmission errors without requiring retransmission of the original data. To achieve this, transmitted data is divided into units called codewords, which include both data bits representing the actual information being sent and redundancy bits generated using specific algorithms. These redundancy bits enable the receiver to detect and correct errors in the data bits. Codewords help to enable reliable communication over potentially noisy or interference-prone upstream channels in a cable network. In instances in which errors occur during transmission, the FEC mechanism uses the redundancy bits to correct errors within the codeword if the number of errors falls within the correction capability of the chosen FEC scheme.

In instances in which a cable modem is granted transmission on an upstream channel, the CMTS continuously monitors the FEC codewords received from the cable modem to assess the quality of the transmission. First, the cable modem encodes its data into FEC codewords and transmits them to the CMTS over the assigned upstream channel. Each codeword contains data and redundancy bits, ensuring that errors can be corrected by the CMTS on the receiving end.

Upon receiving the data from the cable modem, the CMTS decodes the FEC codewords, comparing the data bits against the redundancy bits to identify any errors. In the event that errors are detected within the codeword, the CMTS attempts to correct these errors using the redundancy bits.

The CMTS logs the occurrence of errors for further analysis. In instances in which the bit errors in the codeword are within the correction capacity of the FEC algorithm, such errors are categorized as correctable errors, meaning that the CMTS successfully corrected them and restored the original data. In instances in which the number of bit errors in a given codeword exceeds the FEC scheme's capability to correct, the CMTS logs the event as an uncorrectable error.

In addition to correcting errors, the CMTS maintains statistics for each upstream channel, including counts of correctable and uncorrectable errors. This information is used to evaluate the performance of the upstream channels assigned to each cable modem. In instances in which excessive uncorrectable errors occur on a given upstream channel, the CMTS may respond by reassigning a different upstream channel to the cable modem, adjusting modulation profiles, suspending use of the upstream channel by listing it as impaired, or taking other corrective actions to improve the overall transmission quality. For example, in the latest DOCSIS 3.1 standard, OFDMA-modulated channels are used, which have multiple levels of modulation. This enables the CMTS to adjust or change the modulation scheme used in an upstream channel based on the error rate observed in the channel, and if the channel continues to experience unacceptable error rates using the lowest modulation level, the CMTS may mark the channel as impaired.

In a DOCSIS cable services network, the CMTS is typically responsible for managing the upstream channels for all cable modems. The CMTS is responsible for providing communication grants on available upstream channels in response to requests by the cable modem to transmit upstream data. During upstream communications from cable modems the CMTS monitors the codewords from cable modems on all applicable upstream channels, and based on this monitoring, will decide whether an upstream channel should be used by a cable modem or impaired to prevent further use by the cable modem.

In a DOCSIS-compliant network, the CMTS may impair or prevent further use of an upstream channel by sending a Dynamic Bonding Change (DBC) message to the cable modem. The DBC message enables the CMTS to dynamically modify the set of upstream channels assigned to the cable modem. The DBC message is structured using a Type-Length-Value (TLV) encoding system and includes several key fields. These fields include the Bonding Group identifier (ID), which identifies the bonding group of upstream channels to which the cable modem is assigned, and the Channel List, which specifies the channels to be added or removed from the modem's active bonded upstream channel set. Additionally, the DBC message includes the Target Channel Set, which defines the final set of upstream channels after the bonding change is complete. A Modulation Profiles field may also be included, which specifies the modulation parameters for new channels assigned to the modem. The DBC message further specifies the Time to Complete Change, which indicates the time frame within which the cable modem must complete the reconfiguration. An Acknowledgment Required Flag may be set, indicating that the CMTS requires confirmation from the cable modem once the bonding change has been successfully implemented. The DBC message is also assigned a Message Sequence Number to ensure proper sequencing and error handling by the cable modem. In instances in which the cable modem is unable to comply with the DBC request, such as due to hardware limitations or inadequate signal quality, it will send a failure response to the CMTS, enabling the system to take corrective action.

By monitoring FEC codewords, evaluating the error statistics, and impairing upstream channels exhibiting unacceptable rates of uncorrectable errors, the CMTS may ensure the ongoing integrity and reliability of data transmission between cable modems and the network. However, this makes the CMTS a single point of failure if the CMTS does not perform its function properly and the CMTS allows the cable modem to transmit using a bad channel.

If for some reason the CMTS does not recognize instances in which uncorrectable codewords are increasing in a bonded upstream channel and the upstream channel is not put into the impaired state, the CMTS will continue issuing communication grants to the cable modem on that upstream channel. The cable modem will comply with communication grants and continue to transmit upstream packets on that channel. However, the degradation in the upstream channel may cause transmitted packets/codewords to be dropped by the CMTS in instances in which the amount of bit errors in codewords exceeds the error correction capabilities of the FEC mechanism in the channel's modulation scheme. As a result, data and commands sent by the cable modem may never reach their destination, significantly impacting the upstream communication throughput and performance of the network.

Various embodiments address problems that may result from the CMTS failing to recognize that a bonded upstream channel is experiencing unacceptable uncorrectable error rates by enabling either cable modems or an external system (i.e., a network element separate from the CMTS) to monitor upstream channel FEC codewords and inform the CMTS when an upstream channel should be impaired. In this manner, an upstream channel experiencing unacceptable transmission quality may be recognized by either the CMTS or the cable modem or external system.

In a first embodiment, cable modems are configured to monitor upstream channel FEC data or uncorrectable error rates to determine whether a predefined uncorrectable error rate threshold is satisfied (e.g., equaled or exceeded). Since the cable modem is already aware of its data transmission, during the data transmission period, the cable modem may periodically request FEC codewords data from CMTS for each upstream channel on which it is transmitting. Using the FEC data received from the CMTS, the cable modem may determine whether any upstream channel is experiencing an unacceptable rate of uncorrectable codewords (i.e., error rate equals or exceeds a predefined error rate threshold) but communication grants are still being received from the CMTS on the channel. In instances in which such a condition is detected, the cable modem may send a message to the CMTS indicating that the identified upstream channel should be changed to the impaired state, or in the case of an Orthogonal Frequency-Division Multiplexing (OFDMA) channel, use a lower modulation, if the channel is not already at the lowest modulation. This may require implementing new message types to support these communications between CMTS and cable modem. As a non-limiting example, this message may be a specific type of management traffic message that includes a channel identifier (ID) and an event type, such as “impair” or “recover.”

In response to receiving the cable modem's request message, the CMTS may use DBC messages, such as a DBC-REQ message, to change the upstream channels assigned to the cable modem to suspend use of the identified upstream channel or lower the modulation used in and OFDMA channel. The cable modem may respond with a response message by implementing the instructions to stop use of the channel or lower the modulation used in the channel and send a response message, such as a DBC-RSP message, indicating implementation or its ability to implement the change in bonded upstream channels. Thereafter, the CMTS may avoid granting communication opportunities on the impaired upstream channel.

In instances in which the error rate of an impaired upstream channel improves to an acceptable level (e.g., with an uncorrectable error rate less than the predefined error rate threshold), the CMTS may recognize this and recover or raise the modulation used in the upstream channel in a conventional manner (e.g., according to DOCSIS protocols). Alternatively, the cable modem may recognize the improvement from FEC data received from the CMTS and signal the CMTS to recover or raise the modulation used in the channel. In response, the CMTS may use the DBC messages to change the upstream channels assigned to the cable modem to recover, reallocate, or raise the modulation used for the previously-impaired upstream channel.

In a second embodiment, instead of configuring cable modems to monitor upstream channel quality, an external system or functionality (i.e., external to the CMTS) may be included in the cable service network to monitor error rates in cable modem upstream channels and instruct the CMTS regarding managing upstream channels, including switching channels with unacceptable error rates to the impaired state or lower modulation, and recovering impaired or raising modulation of upstream channels when their error rates improve to acceptable levels. Such an external system may be located in a variety of network elements within the cable service network, such as in a network management system element, within a server within the network management system, or in a standalone server (or similar computing device) positioned within the back office network.

In such embodiments, an external system may access the FEC data for all connected cable modems and all upstream channels used by the connected cable modems on a regular interval. The external system may also obtain data from the CMTS related to the communication grants issued to cable modems by the CMTS. The external system may use this data to continuously or periodically monitor all active upstream channels to recognize when the error rate in any channel exceeds an acceptable level (i.e., equals or exceeds a predefined error rate threshold). In instances in which the external system finds that there are considerable uncorrectable FEC codewords issuing for an upstream channel and the CMTS is continuing to grant communications using the channel, the external system may send a message to the CMTS identifying the upstream channel and instruct the CMTS to impair or lower the modulation (for OFDMA channels) of the identified upstream channel, such as by removing the channel from the assigned list of upstream channels for the particular cable modem. The CMTS may then send a DBC message to the affected cable modem to convey the channel reassignment or modulation change information and, in the case of impaired channels, stop assigning communication grants on the identified upstream channel to the cable modem.

In instances in which the error rate of an impaired or lowered modulation upstream channel improves to an acceptable level (e.g., less than the predefined error rate threshold), the CMTS may recognize this and recover or raise the modulation of the upstream channel in a conventional manner. Alternatively, the external system may recognize the improvement from monitored FEC data or other error rate statistics and signal the CMTS to recover the improving upstream channel.

In various embodiments, the error rate thresholds used by either cable modems or an external system may be a rate of uncorrectable packets/codewords or a number or count of uncorrectable packets/codewords processed within a specific time frame. For ease of reference, either method of formatting thresholds are referred to herein as an “error rate.” An unacceptable error rate threshold (referred to herein sometimes as an error rate threshold) may depend upon the type of modulation used for a particular upstream channel as the modulation scheme may affect how resilient a communication channel is to noise that may cause reception of uncorrectable packets. Since upstream channels may be configured with one of several alternative modulation schemes and discussed above, in some embodiments the cable modems or external system may select the proper predefined error rate threshold to use in analyzing a given channel from a database or data table of predefined error rate thresholds based on the modulation scheme implemented in that channel.

FIG. 1A is a system block diagram of a high-level representation of elements within a cable services network 100 that is suitable for implementing some embodiments. Such a network may include a network management system (NMS) 102 and provisioning systems 108 connected via a back office network 104 that provide network services to a CMTS 106 for distribution via a hybrid fiber/cable network (HFC) 110 to a number of cable modems 116 that support home networks 112. Video, audio, and other cable services may be provided by the NMS 102 and provisioning systems 108 to the CMTS 106 for distribution to individual cable modems 116 for rendering on user devices 114. Additionally, user devices 114 within home networks 112 may send upstream communications via the network 100, such as queries to Internet websites. Such upstream communications may be carried from the cable modem 116 via the HFC network 110 to the CMTS 106 that routes the upstream communication to the appropriate network via the back office network 104. Additionally, the cable modems 116 and the CMTS 106 exchange communications for managing download and upload communications via the HFC network 110.

FIG. 1B is a system block diagram of a high-level representation of elements within the cable services network 120 suitable for implementing some embodiments that includes an additional network element, referred to as an “external system” for monitoring error rates in cable modem upstream communication channels. The network 120 is similar to the network 100 illustrated in FIG. 1A with the addition of the external system 102a. While the external system 102a is illustrated as being located in an element of the network management system 102 (NMS in the figure), the system or functionality may be located within a variety of network elements of the cable service network 100, such as in a separate server within the network management system 102 or multiple system operator (MSO) premises (not shown), or in a standalone server (or similar computing device) positioned within (i.e., connected to) the back office network 104. Functionality of the external system 102a is described in detail below.

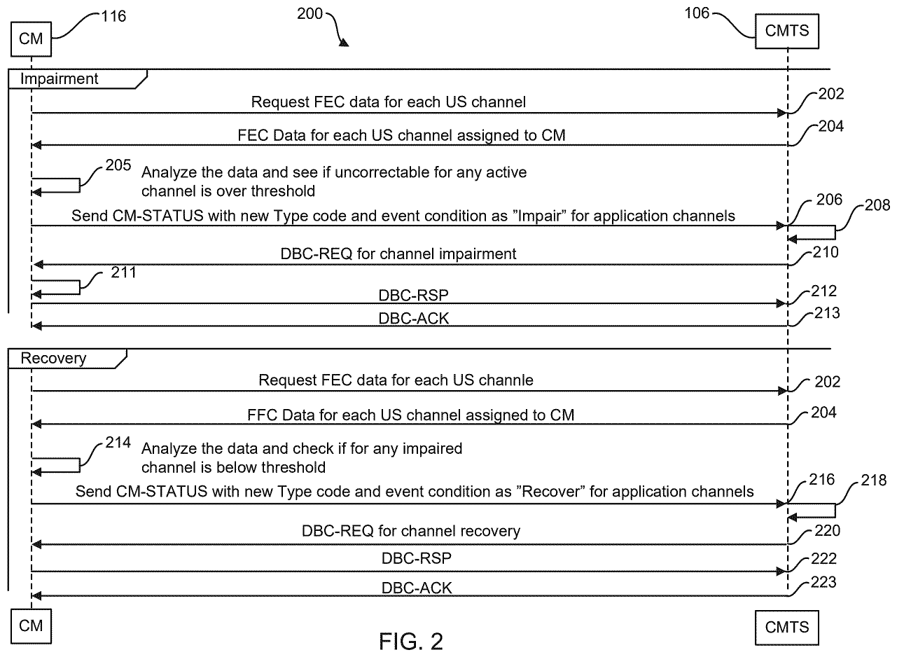

FIG. 2 is a message flow diagram illustrating messages that may be exchanged between a cable modem 116 and the CMTS 106 in some embodiments that enable the cable modem 116 to identify to the CMTS 106 any upstream channels with unacceptable error rates that should be impaired or modulation lowered, as well as identifying when an impaired upstream channel should be recovered.

In message 202, the cable modem 116 (“CM” in the figure) sends a message to the CMTS 106, requesting FEC data (or other message error rate data) for each upstream channel to which the cable modem 116 is assigned. The message may include a request for the error rates and FEC statistics for all active upstream channels. The purpose of this message is for the cable modem 116 to collect data on channel performance, allowing the cable modem 116 to assess the usability of the assigned upstream channels.

In message 204, after receiving the request for FEC data message, the CMTS 106 may send a message 204 to the cable modem 116 providing the FEC data and/or other error rate statistics for each upstream channel. This message 204 may include an identifier of each upstream channel with error rate data linked or correlated to each upstream channel identifier. A new format message may need to be added to a DOCSIS standard to implement this communication.

In operation 205, in response to receiving the FEC data (or other message error rate data) from the CMTS 106, the cable modem 116 may perform an analysis of the FEC and/or error rate data to determine whether the error rate for any of the active upstream channels exceeds a predetermined error rate threshold of unacceptable quality. As described herein, the threshold used in this analysis may be predefined and appropriate for the type of modulation used in each of the active upstream channels. Thus, in response to determining that the error rate for a channel is above the corresponding predefined error rate threshold, the cable modem 116 prepares to send an impairment or reduced modulation notification to the CMTS 106.

In message 206, the cable modem 116 may send a message to the CMTS 106 with a CM-STATUS notification. This message 206 may include a new type code and event condition labeled as “Impair” to indicate that one or more upstream channels should be designated as impaired or use a lowered modulation due to excessive error rates. The purpose of this message is to prompt the CMTS 106 to take actions to adjust the channel assignments based on the indication. A new format message may need to be added to a DOCSIS standard to define this type of notification.

In operation 208, in response to receiving the “Impair” message 206 from the cable modem 116, the CMTS 106 may process the request and take actions to mark or recategorize the identified upstream channel to the impaired state or reduce its modulation in the case of an OFDMA channel. This operation 208 may include formatting a DBC-REQ message to send to the cable modem 116.

In message 210, the CMTS 106 responds to the cable modem's impairment notification by sending a DBC-REQ message for channel impairment that instructs the cable modem to take actions for changing the assigned or bonded upstream channels to reflect the identified impaired upstream channel or to lower the modulation if it is an OFDMA channel. In some embodiments, this message 210 may include the CMTS's request for confirmation that the cable modem 116 implemented the requested changes and can handle the dynamic bonding change necessary to address the impaired upstream channel. By sending this message the CMTS 106 instructs the cable modem 116 to adjust its upstream bonding configuration to exclude the impaired upstream channel or lower the modulation used in the channel.

In operation 211, in response to receiving the DBC-REQ message from the CMTS 106, the cable modem 116 processes the request and takes the action necessary to modify the bonding configuration as instructed. In some embodiments, this operation may involve determining whether the cable modem 116 may successfully adjust its configuration to continue transmitting on the remaining upstream channels while excluding the impaired upstream channel.

In message 212, after completing its internal actions in operation 211, the cable modem 116 sends a DBC-RSP (Response) message to the CMTS 106, which may confirm that the cable modem has modified the bonding configuration as instructed by the CMTS 106. In some embodiments, the message 212 may include information regarding the cable modem's ability to handle the dynamic bonding change. This message may include confirmation of the cable modem's readiness to adjust its upstream channel configuration as requested. To complete the exchange, the CMTS 106 may respond to the DBC-RSP with an acknowledgement DBC-ACK message 213. Thereafter, the cable modem 116 may suspend using the impaired upstream channel for communications with the CMTS 106.

In some embodiments, the cable modem may continue to monitor FEC data or other error rate information from an impaired upstream channel to identify when the channel may be returned to service (i.e., “recovered”). In such embodiments, the cable modem 116 may continue (e.g., periodically) to send messages 202 to the CMTS 106 requesting updated FEC data or other message error rate statistics for the impaired upstream channel. In some embodiments, this message may be similar in content to the message 202 described above for requesting FEC data (or other message error rate data) for all assigned upstream channels. This message may include a request for error rate data that the cable modem may use to determine whether the impaired upstream channel's error conditions have improved.

Similar as described above, after receiving the request for FEC data message, the CMTS 106 may send a message 204 to the cable modem 116 providing the FEC data and/or other error rate statistics for each upstream channel, including in particular the impaired upstream channel. As described, this message may include identifiers of specific upstream channels with error rate data linked or correlated to the upstream channel identifier. A new format message may need to be added to a DOCSIS standard to implement this communication.

In operation 214, after receiving the updated FEC data, the cable modem 116 may analyze the data to determine whether a previously impaired upstream channel or OFDMA channel using a reduced modulation has improved such that its FEC data or other error rate data is now less than the threshold of unacceptable error rates or quality. In instances in which the error rates for the channel fall below the threshold, the cable modem 116 prepares a message to notify the CMTS 106 of the recovery or ability to raise modulation.

In message 216, the cable modem 116 may send a CM-STATUS notification message to the CMTS 106, indicating that the error rate for the previously impaired upstream channel has fallen below the threshold. The message may include a new type code and event condition labeled as “Recover,” signaling that the channel is ready to be reinstated for regular use or raised modulation. A new type code and event condition may need to be added to a DOCSIS standard to communicate this information.

In operation 218, the cable modem 116 processes the CM-STATUS notification message and prepares to adjust its bonding configuration to reintroduce the recovered upstream channel. This may involve verifying that the modem can resume using the upstream channel or raise the channel's modulation (if an OFDMA channel) without causing further errors.

In message 220, the CMTS 106 responds to the recovery notification by sending a DBC-REQ message to the cable modem 116. This message requests instructs the cable modem 116 to take actions for re-adding the previously impaired upstream channel to its upstream bonding configuration or raising the modulation used in an OFDMA channel. This message may also identify the upstream channel and specify the modulation of the channel that the cable modem should use.

In message 222, the cable modem 116 sends a DBC-RSP (Response) message to the CMTS 106, confirming it has performed the requested dynamic bonding change necessary to reintroduce the recovered upstream channel or raise the modulation used in the channel. This message may include a confirmation that the cable modem 116 is ready to resume upstream communication on the channel previously marked as impaired. To complete the exchange, the CMTS 106 may respond with an acknowledgment DBC-ACK message 223. Thereafter, the cable modem may implement the modulation for the recovered upstream channel and begin using it again for communicating with the CMTS 106.

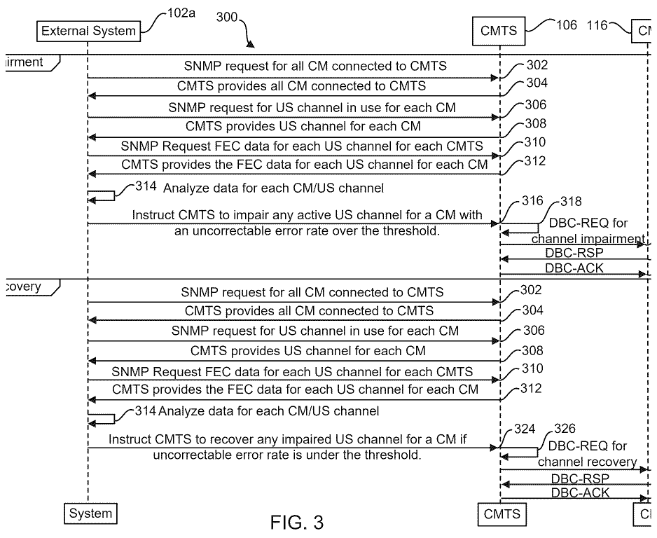

FIG. 3 is a message flow diagram illustrating messages exchanged between an external system or network element, a CMTS 106, and a cable modem 116 in some embodiments that use a network element 102a separate from the CMTS 106 (referred to as an “external system” in the figure) to identify to the CMTS 106 any upstream channels with unacceptable error rates that should be impaired, as well as identifying when an impaired upstream channel should be recovered.

In message 302, the external system 102a may send a request to the CMTS 106 for a list of all cable modems (“CM” in the figure) currently connected to the CMTS 106. This request may be sent using a Simple Network Management Protocol (SNMP) message. The purpose of this message is to enable the external system to learn about the active cable modems within the network and prepare for the subsequent monitoring of their upstream communication channels.

In response to the external system's request, the CMTS 106 sends an SNMP message 304 back to the external system 102a providing a list of all connected cable modems. The message may contain the identifiers of each CM connected to the CMTS 106. This information may be used by the external system to identify the cable modems it will monitor for upstream channel performance.

In message 306, the external system 102a sends a second SNMP request to the CMTS 106 asking for details on the upstream communication channels currently in use by each connected cable modem 116. This message allows the external system to retrieve information on which upstream channels are assigned to each cable modem 116, as these channels will be the focus of the error rate monitoring.

In message 308, the CMTS 106 responds to the external system's request by sending an SNMP message containing the upstream channel assignments for each cable modem 116. The message may include details on the channels currently used for upstream communication, such as channel identifiers and the type of modulation used in each channel. This information enables the external system to monitor the error rates on the appropriate channels for each modem.

In message 310, the external system 102a sends an SNMP request to the CMTS 106, requesting FEC data (or other error rate data) for each upstream channel used by each cable modem 116. The message may include a request for the FEC statistics needed to evaluate the performance and error rates of the upstream channels. This data will be used to identify any channels that may be experiencing high error rates.

In message 312, the CMTS 106 provides the requested FEC data (or other message error rate data) to the external system in response to the SNMP request. The message may include FEC error statistics for each upstream channel, including the number of correctable and uncorrectable codewords. This data may be used by the external system to assess the quality of upstream transmissions. A new type code and event condition may need to be added to a DOCSIS standard to communicate this information.

In operation 314, the external system 102a analyzes the FEC data (or other message error rate data) for each cable modem's upstream channels to determine whether the error rates exceed a predetermined threshold. In instances in which the uncorrectable error rate for any channel is above the acceptable limit, the external system prepares to instruct the CMTS 106 to mark the channel as impaired.

In response to detecting a channel with excessive error rates, the external system 102a may send a message 316 to the CMTS 106 instructing the CMTS to impair any active upstream channel for a cable modem 116 in which the uncorrectable error rate exceeds the threshold. The purpose of this message is to prompt the CMTS 106 to stop using the impaired upstream channel or lower the modulation used for upstream communication, mitigating the impact of the errors. A new type code and event condition may need to be added to a DOCSIS standard to communicate this information.

Operation 318, after receiving the impairment instruction from the external system, the CMTS 106 prepares to impair the affected upstream channel by stopping the allocation of grants to that channel or by lowering the modulation used in the channel. This operation ensures that the cable modem 116 will no longer use the impaired upstream channel for data transmission or will use a modulation scheme compatible with the observed error rate.

In message 320, the CMTS 106 sends a DBC-REQ message to the affected cable modem 116, identifying the upstream channel to be impaired and requesting confirmation that the modem is ready to adjust its upstream bonding configuration to exclude the impaired upstream channel or lower the modulation used in the channel. The message serves to verify that the cable modem 116 can handle this dynamic bonding change.

In response to the DBC-REQ, the cable modem 116 sends a DBC-RSP message 322 to the CMTS 106, confirming that it has completed the requested actions to implement the dynamic bonding change impairing or lowering the modulation used in the identified upstream channel. This message assures the CMTS 106 that the cable modem 116 has reconfigured its upstream channels to exclude the impaired upstream channel or implement the lowered modulation. To complete the DBC exchange, the CMTS 106 may respond to the DBC-RSP with an acknowledgement DBC-ACK message 323. Thereafter, the cable modem 116 may suspend using the impaired upstream channel for communications with the CMTS 106.

The external system 102a may continue to monitor all upstream channels of all connected cable modems, including impaired upstream channels using similar processes. For example, the external system 102a and the CMTS 106 may exchange messages 302-312 as described above to update the cable modems connected to the CMTS 106 and the upstream channels bonded to the cable modems 116, and continue to receive FEC data (or other error rate data) for all of the upstream channels assigned to the connected cable modems. Similarly, the external system 102a may perform operations 314 to analyze the error rate data in each cable modem upstream channel, comparing the error rate data to thresholds appropriate for the modulation scheme of each channel, including analyzing the error rate data in any impaired cable modem upstream channel.

In response to identifying one or more impaired upstream channel in which the error rate data has fallen below the corresponding threshold of unacceptable errors, the external system 102a may send a message 324 to the CMTS 106 instructing it to recover any previously impaired upstream channels for which the uncorrectable error rate has fallen below the threshold. The purpose of this message is to prompt the CMTS 106 to restore the use or raise the modulation of channels that were previously impaired but have since improved in quality to acceptable error rates. A new type code and event condition may need to be added to a DOCSIS standard to communicate this information.

In operation 326, after receiving the recovery instruction message 324, the CMTS 106 prepares to recover the previously impaired or lowered modulation upstream channel by re-adding it to the available channels or raising modulation for the cable modem 116. This operation ensures that the modem 116 may resume using the recovered channel for upstream communication.

In message 328, the CMTS 106 sends a DBC-REQ message to the cable modem 116 requesting the cable modem 116 may return the previously impaired upstream channel to its bonding configuration. This message may include an identifier of the upstream channel and may also include the modulation type to use in the upstream channel.

In message 330, in response to the DBC-REQ, the cable modem 116 sends a DBC-RSP (Dynamic Bonding Change Response) message to the CMTS 106, confirming that it has completed the requested actions to recover the previously impaired upstream channel. This message ensures that the cable modem 116 is ready to resume communication on the channel that has now been restored to regular status. To complete the DBC exchange, the CMTS 106 may respond to the DBC-RSP with an acknowledgement DBC-ACK message 331. Thereafter, the cable modem 116 may implement the modulation for the recovered upstream channel and begin using it again for communicating with the CMTS 106.

As noted herein, some of the messages used to implement various embodiments may need to be defined as new types or formats of messages, such as in a future release of DOCSIS. Some non-limiting examples of message types that might be modified for such new format messages include Simple Network Management Protocol (SNMP) messages, such as a SNMP SetRequest message, Media Access Control (MAC) management messages, or DOCSIS control plane protocol messages (e.g., Internet Protocol Detail Record (IPDR) or DOCSIS operations support system interface (OSSI) messages. In embodiments implemented in an external system 102a, some new messages may be defined in a new control plane extension of the CMTS that allows the external system to send direct commands to the CMTS.

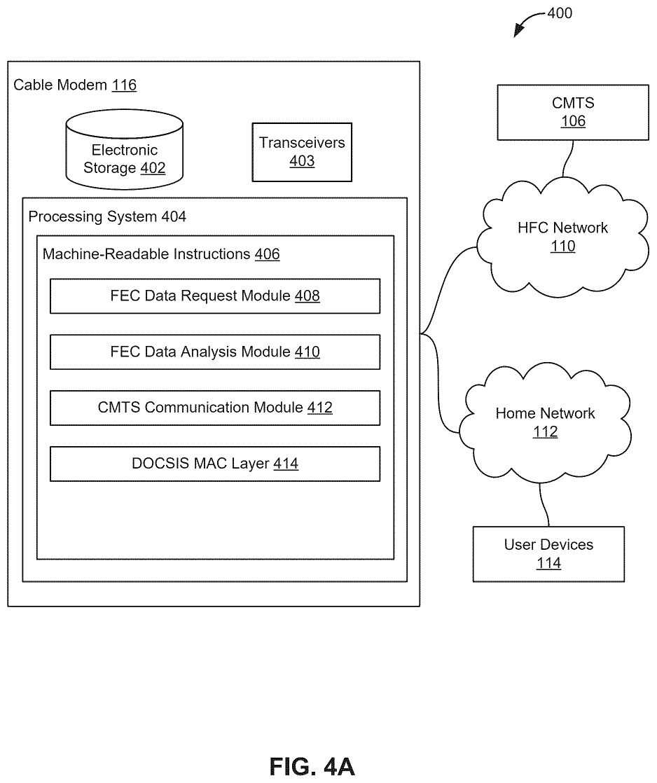

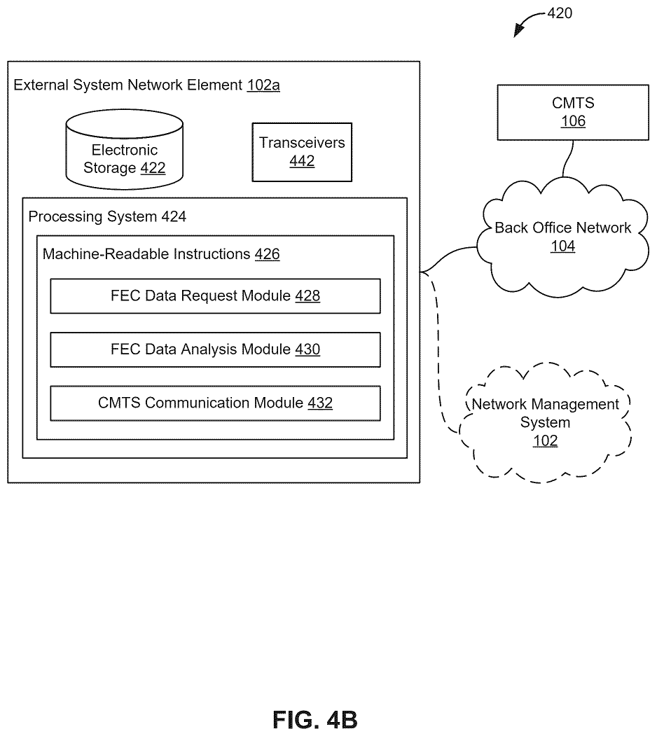

FIG. 4A is a component block diagram illustrating a cable services network system 400 including a cable modem 116 in which the cable modem is configured to inform the CMTS 106 when an upstream channel should be impaired or recovered in accordance with various embodiments. With reference to FIGS. 1A-4A, the cable services network system 400 may include a CMTS 106 coupled to a cable modem 116 via an HFC network 110, and a home network 112 coupled to the cable modem 116 to provide cable network services (download data and upstream commands and communications) to user devices 114. The cable modem 116 may include a processing system 404 coupled to electronic storage 402 and one or more transceivers 403. The transceivers 403 may be configured to communicate via the HFC network 110 and the home network, which may include via Wi-Fi wireless communications.

The processing system 404 may be configured to provide information processing capabilities in the cable modem 116. As such, the processing system 404 may include one or more of a digital processor, an analog processor, a digital circuit designed to process information, an analog circuit designed to process information, a state machine, and/or other mechanisms for electronically processing information. Although the processing system 404 is illustrated as a single entity, this is for illustrative purposes only and the processing system 404 may include a plurality of processing units and/or processor cores. In some embodiments, the processing units may be physically located within the same device, or processing system(s) 404 may represent processing functionality of a plurality of devices operating in coordination.

The processing system 404 may be configured by machine-readable instructions 406 that may be stored in the electronic storage 402. Machine-readable instructions 406 may include one or more instruction modules. As used herein, the term “module” may refer to any component or set of components that perform the functionality attributed to the module. The instruction modules may include computer program modules. In some embodiments, the functions of the instruction modules may be implemented in software, firmware, hardware (e.g., circuitry), or a combination of software and hardware, which are configured to perform particular operations or functions. The instruction modules may include one or more of an FEC data request module 408, an FEC data analysis module 410, a CMTS communication module 412, a DOCSIS media access control (MAC) layer, and/or other instruction modules.

The FEC data request module 408 may be configured to periodically or episodically send a message to the CMTS 106 requesting FEC data or other error statistics for communications in assigned or bonded upstream channels and receiving the requested data from the CMTS 106. The FEC data request module 408 may request statistics on the rate of unrecoverable error codewords (or number of unrecoverable error codewords within a set duration). As described, the FEC data request module 408 may be configured to generate a message that identifies an upstream channel (e.g., by including a channel identifier). In some embodiments, the FEC data request module 408 may be configured to generate the FEC data request message in response to an event, such as during or following an upstream communication session with the CMTS. To support the requests for such data, the FEC data request module 408 may be configured to generate a new message format that may be added to a DOCSIS protocol release. The FEC data request module 408 may interact with the CMTS communication module 412 for sending the generated request message to the CMTS and receiving the requested data from the CMTS.

The FEC data analysis module 410 may be configured to analyze the FEC data or other error statistics (e.g., rate of unrecoverable FEC codewords) received from the CMTS 106 to determine whether an error rate in any assigned upstream channel exceeds a predefined error threshold corresponding to the type of modulation used in a respective assigned upstream channel. To support this functionality, the FEC data analysis module 410 may be configured to identify the correct threshold to use for analyzing the type of modulation scheme used in each upstream channel. In some embodiments, the FEC data analysis module 410 may identify the correct threshold using the modulation type of each upstream channel to look up a corresponding threshold in a data table or database of unacceptable error rates linked to modulation types.

In performing the analysis of FEC data or error rate statistics, the FEC data analysis module 410 may be configured to compare the FEC error data (i.e., FEC codewords, statistics on unrecoverable errors, etc.) received from the CMTS for each channel to the corresponding threshold, such as through a math comparison (e.g., subtraction and test for the sign of the remainder), to recognize when the threshold of unacceptable unrecoverable FEC codewords is equaled or exceeded (or not satisfied depending on the format of the threshold). In some embodiments, the FEC data analysis module 410 may be configured to continue analyzing FEC data or error rate statistics on impaired upstream channels to recognize when the threshold of unacceptable unrecoverable FEC codewords is no longer equaled or exceeded, indicating that the channel can be recovered. The FEC data analysis module 410 may provide to the CMTS communication module 412 for communicating with the CMTS the identifier of any upstream channel with unacceptable uncorrectable error rates (e.g., equaling or exceeding a threshold) and/or any impaired upstream channel for which the FEC data or other error rate statistics have improved to acceptable levels (e.g., less than the threshold).

The CMTS communication module 412 may be configured to send messages to and receive messages from the CMTS 106. In addition to conventional communications to/from the CMTS 106, the CMTS communication module 412 may be configured to send messages requesting FEC data or other error statistics as generated by the FEC data request module 408, send messages to the CMTS 106 identifying an upstream channel that should be impaired, send messages to the CMTS 106 identifying an impaired upstream channel that should be recovered, and responding to DBC messages from the CMTS 106, such as DBC-RSP messages 212, 222 as described herein.

The DOCSIS MAC layer 414 may be configured to manage the data transmission between the cable modem and the CMTS 106. The MAC layer 106 handles various essential functions such as channel access, bandwidth allocation, error correction, and maintaining data flow control to ensure that multiple devices can communicate efficiently over the shared network infrastructure. This layer controls the allocation of upstream and downstream channels, handles grant requests for upstream transmission, and manages channel bonding. The DOCSIS MAC layer 414 may be responsible for handling communication with the CMTS 106, including sending requests for DBC messages or stopping grant requests on impaired upstream channels. It may also handle channel reassignment commands and manage data streams for the assigned channels.

The electronic storage 402 may include non-transitory storage media that electronically stores information. The electronic storage media of electronic storage 402 may include one or both of system storage that is provided integrally (i.e., substantially non-removable) with the cable modem 116 and/or removable storage that is removably connectable to the cable modem 116 via, for example, a port (e.g., a universal serial bus (USB) port, a firewire port, etc.) or a drive (e.g., a disk drive, etc.). The electronic storage 402 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 402 may include one or more virtual storage resources (e.g., cloud storage, a virtual private network, and/or other virtual storage resources). The electronic storage 402 may store software algorithms, information determined by the processing system(s) 404, information received from the cable modem 116, or other information that enables the cable modem 116 to function as described herein.

The description of the functionality provided by the different modules 408-414 is for illustrative purposes, and is not intended to be limiting, as any of modules 408-414 may provide more or less functionality than is described. For example, one or more of the modules 408-414 may be eliminated, and some or all of its functionality may be provided by other modules. As another example, the processing system(s) 404 may be configured to execute one or more additional modules that may perform some or all of the functionality of the modules 408-414.

FIG. 4B is a component block diagram illustrating a cable services network system 420 including an external system 102a configured to inform at least one CMTS 106 when an upstream channel should be impaired or recovered in accordance with various embodiments. With reference to FIGS. 1A-4B, the external system 102a may be a network element computing device positioned at any of a variety of network locations within the back office network 104 (including within the NMS 102 facility) but external to the CMTS, which is why this network element is referred to as an “external system.” The cable services network system 420 may include the external system 102a, which may be a network element configured to communicate with at least one CMTS 106 via a back office network 104, and optionally with a network management system 102. In some implementations, the cable services network system 420 may include multiple CMTSs, each connected to a plurality of cable modems, with the external system 102a configured to monitor upstream communications among every CMTS and each associated cable modem within the system. The external system 102a may include at least one processing system 424 coupled to electronic storage 422 and transceivers 424. The transceivers 424 may be configured to communicate via connected networks, including the back office network 104.

The processing system 424 may include one or more of a digital processor, an analog processor, a digital circuit designed to process information, an analog circuit designed to process information, a state machine, and/or other mechanisms for electronically processing information. Although the processing system 424 is illustrated as a single entity, this is for illustrative purposes only and the processing system 424 may include a plurality of processing units and/or processor cores.

The processing system(s) 424 may be configured by machine-readable instructions 426. Machine-readable instructions 426 may include one or more instruction modules. The instruction modules may include computer program modules. In some embodiments, the functions of the instruction modules may be implemented in software, firmware, hardware (e.g., circuitry), or a combination of software and hardware, which are configured to perform particular operations or functions. The instruction modules may include one or more of an FEC data access module 428, an FEC data analysis module 430, a CMTS communication module 432, and/or other instruction modules.

The FEC data access module 428 may be configured to continuously or periodically obtain FEC data or other error statistics for communications in all bonded upstream channels assigned or bonded to all cable modems communicating with the CMTS. The FEC data access module 408 may obtain FEC data codewords or statistics on the rate of unrecoverable error codewords (or number of unrecoverable error codewords within a set duration) in all active upstream channels between cable modems and the CMTS.

As the external system 102a may be located in a variety of locations within the cable services network system 420, the system may obtain FEC data or other error statistics in a variety of ways depending on its network location and data connections to other network elements, including the CMTS. In some embodiments, the external system 102a may have direct access to the CMTS or memory locations within the CMTS that enable the external system to obtain the communication FEC codewords as they are generated by the CMTS without the need to request the data. In some embodiments, the external system 102a may be configured to exchange messages with the CMTS, such as via the back office network 104, including messages periodically requesting FEC data or statistics for upstream communication channels from the CMTS. In some embodiments, the external system 102a may be connected to (e.g., directly or via the back office network 204) or included as part of a poller within a network side interface (NSI), or as part of the multiple system operator (MSO) equipment, that is coupled to the CMTS. In such embodiments, the external system 102a may have access to a near-continuous feed of network health and status information. The poller is a critical network device or functionality that typically queries network devices (e.g., CMTSs, cable modems, routers, and switches) at regular intervals using management protocols like the Simple Network Management Protocol (SNMP), such as SNMP GetRequests, to obtain performance metrics, device status, and/or error rates (e.g., FEC codeword statistics).

The FEC data analysis module 430 may be configured to analyze the FEC data or other error statistics obtained from the CMTS 106 or from another network element to determine whether an error rate in any assigned upstream channel assigned to any cable modem connected to the CMTS 106 exceeds a predefined acceptable error rate threshold corresponding to a type of modulation used in a respective assigned upstream channel. To support this functionality, the FEC data analysis module 430 may be configured to identify the correct threshold to use for analyzing the type of modulation scheme used in each monitored upstream channel. This may involve using the modulation type of each upstream channel to look up a corresponding threshold in a data table or database of unacceptable error rates linked to modulation types.

In performing the analysis of FEC data or error rate statistics, the FEC data analysis module 430 may be configured to compare the FEC error data (i.e., FEC codewords, statistics on unrecoverable errors, etc.) received from the CMTS for each channel to the corresponding threshold, such as through a math comparison (e.g., subtraction and test for the sign of the remainder), to recognize when the threshold of acceptable unrecoverable FEC codewords is equaled or exceeded (or not satisfied depending on the format of the threshold). In some embodiments, the FEC data analysis module 430 may be configured to continue analyzing FEC data or error rate statistics on impaired upstream channels to recognize when the threshold of unacceptable unrecoverable FEC codewords is no longer equaled or exceeded, indicating that the channel can be recovered. In some embodiments, The FEC data analysis module 430 may provide to the CMTS communication module 432 for communicating with the CMTS 106 the identifier of any upstream channel with unacceptable uncorrectable error rates (e.g., equaling or exceeding a threshold) and/or any impaired upstream channel for which the FEC data or other error rate statistics have improved to acceptable levels (e.g., less than the threshold).

The CMTS communication module 432 may be configured to communicate with the CMTS 106 to at least inform the CMTS when an upstream channel assigned to a cable modem should be impaired due to unacceptable rates of uncorrectable FEC codewords (or other error statistic) and, in some embodiments, inform the CMTS when an impaired upstream channel can or should be recovered because channel error rates have improved to acceptable levels. The CMTS communication module 432 may use a variety of communication messages or protocols for communicating with the CMTS 106 depending on the location and connections of the external system 102a within the back office network 104. In some embodiments, the external system 102a may have a direct communication channel to the CMTS processing system for identifying upstream channels that should/can be impaired or recovered. In some embodiments, the external system 102a may communicate with the CMTS 106 via the back office network 104, such as by logging into the CMTS and issuing a message or command to mark an identified upstream channel as impaired or recoverable. Other message formats or protocols may be used by the CMTS communication module 432, including new message types and formats that may be defined to support implementation of the external system 102 and various embodiments.

The electronic storage 422 may include non-transitory storage media that electronically stores information. The electronic storage media of electronic storage 422 may include one or both of system storage that is provided integrally (i.e., substantially non-removable) with the external system 102a and/or removable storage that is removably connectable to the external system 102a via, for example, a port (e.g., a universal serial bus (USB) port, a firewire port, etc.) or a drive (e.g., a disk drive, etc.). The electronic storage 422 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 422 may include one or more virtual storage resources (e.g., cloud storage, a virtual private network, and/or other virtual storage resources). The electronic storage 422 may store software algorithms, information determined by the processing system(s) 424, information received from the cable modem 116, or other information that enables the external system 102a to function as described herein.

The description of the functionality provided by the different modules 428-432 is for illustrative purposes, and is not intended to be limiting, as any of modules 428-432 may provide more or less functionality than is described. For example, one or more of the modules 428-432 may be eliminated, and some or all of its functionality may be provided by other modules. As another example, the processing system(s) 424 may be configured to execute one or more additional modules that may perform some or all of the functionality of the modules 428-432.

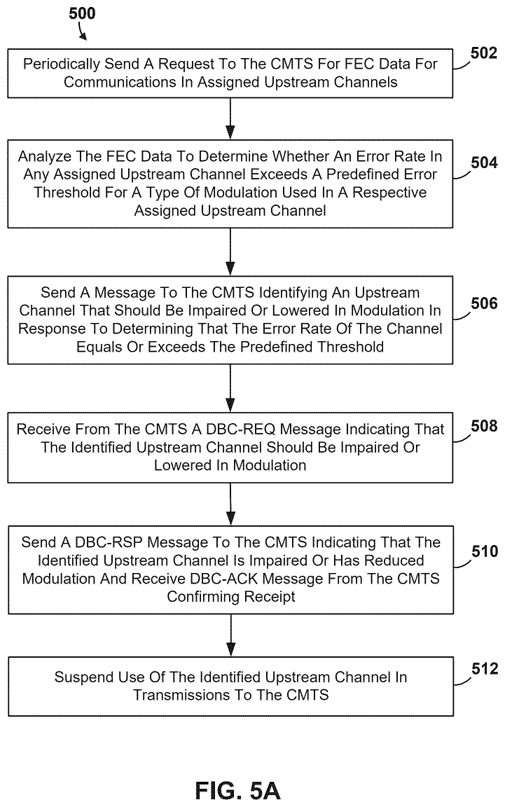

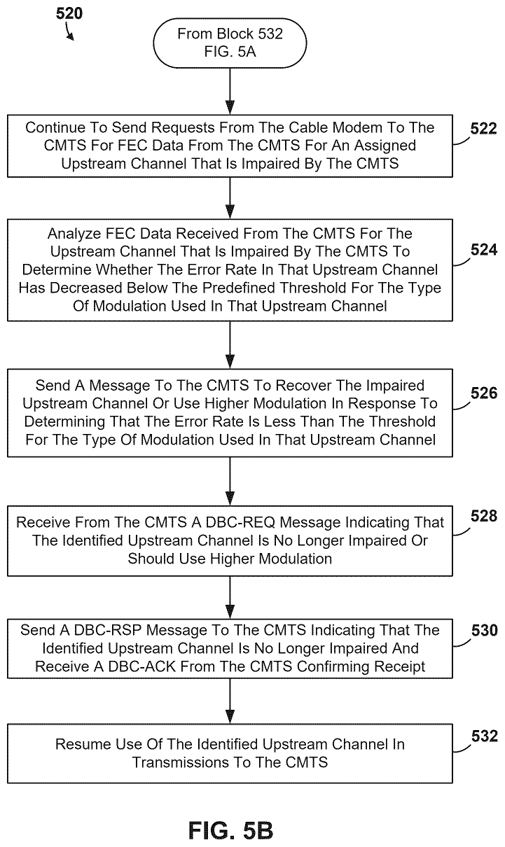

FIG. 5 is a process flow diagram illustrating a method 500 for a cable modem (e.g., 116) to inform a CMTS (e.g., 106) when an upstream channel should be impaired or recovered in accordance with some embodiments. With reference to FIGS. 1A-5, the method 500 may be performed in a cable modem (e.g., 116) by a processing system (e.g., 404) encompassing one or more components or subsystems discussed in this application. Means for performing the functions of the operations in method 500 may include a processing system including one or more processors and other components within a cable modem. Further, one or more processors of a cable modem may be configured with software or firmware (e.g., modules 408-412) to perform some or all of the operations of the method 500. To encompass the alternative configurations enabled in various embodiments, the hardware implementing any or all of the method 500 is referred to herein as a “processing system.”

In block 502, the processing system may perform operations including periodically sending a request to the CMTS 1006 for FEC data or other error rate statistics for or regarding communications in assigned upstream channels. As described herein, a new message type and/or format may need to be defined to support this communication.

In block 504, the processing system 404 may perform operations including analyzing the FEC data or other error rate statistics received from the CMTS 106 to determine whether an error rate in any assigned upstream channel exceeds a predefined error threshold corresponding to a type of modulation used in a respective assigned upstream channel. For example, the processing system 404 may execute a FEC data analysis module 410 to select the appropriate unacceptable uncorrectable error rate threshold corresponding to the type of modulation used by the associated upstream channel and compare the received FEC data or other error rate statistics to the selected threshold to determine whether the unacceptable error rate meets or exceeds that threshold. Such operations may be performed by the FED data analysis module 410 for each bonded upstream channel.

In block 506, the processing system 404 may perform operations including sending, by the cable modem 116, a message to the CMTS 106 identifying an upstream channel that should be impaired or lowered in modulation in response to determining that the error rate of the channel equals or exceeds the corresponding predefined error rate threshold. As described herein, this message may include an identifier for the upstream channel being addressed and a message type such as “impair.” A new message type and/or format may need to be defined to support this communication.

In block 508, the processing system may perform operations including receiving by the cable modem 116 from the CMTS 106 a DBC request (DBC-REQ) message indicating that the identified upstream channel should be impaired or, for OFDMA channels, including instructions to lower its modulation. In the case of OFDMA channels, if the identified upstream channel is already at the lowest modulation, the DBC-REQ may instruct the cable modem to take actions to impair the identified channel (i.e., remove it from the bonded upstream channels). This message may be structured according to the DBC messaging format of the DOCSIS protocol.

In block 510, the processing system 404 may perform operations including sending a DBC-RSP message to the CMTS 106 acknowledging that the identified upstream channel is impaired or has lowered modulation in the case of OFDMA channels. This message may be structured according to the DBC messaging format of the DOCSIS protocol. In the operations in block 510, the processing system may also receive an acknowledgment DBC-ACK message from the CMTS confirming its receipt of the DBC-RSP message.

In block 512, the processing system 404 may perform operations including suspending use of the identified upstream channel in transmissions to the CMTS 106. In some embodiments, such operations may be accomplished by the cable modem avoiding sending the CMTS 106 requests to communicate via the impaired upstream channel. In some embodiments, such operations may be accomplished as a result of the CMTS 106 failing to granting upstream communication opportunities on the impaired upstream channel in response to cable modem 116 requests to communicate to the CMTS 106.

Turning to FIG. 5B, in block 522, the processing system 404 may perform operations including continuing to send requests to the CMTS 106 for FEC data from the CMTS 106 for an assigned upstream channel that is impaired by the CMTS 106. Such a message may include an identifier of the impaired upstream channel(s), or may be the same message as sent by the processing system in block 502. Similar to the operations described for block 502, a new message type and/or format may need to be defined to support this communication.

In block 524, the processing system 404 may perform operations including analyzing FEC data received from the CMTS for the upstream channel that is impaired by the CMTS to determine whether the error rate in that upstream channel has decreased below the predefined error threshold corresponding to the type of modulation used in that upstream channel. Similar to the operations described for block 504, the processing system may execute a FEC data analysis module 410 to select the appropriate unacceptable uncorrectable error rate threshold corresponding to the type of modulation used by the impaired upstream channel and compare the received FEC data or other error rate statistics to the selected threshold to determine whether the unacceptable error rate no longer meets or exceeds that threshold Such operations may be performed by the FED data analysis module 410 for each impaired upstream channel.

In block 526, the processing system 404 may perform operations including sending a message to the CMTS to recover the impaired upstream channel or use higher modulation if an OFDMA channel in response to determining that the error rate is less than the predefined error threshold corresponding to the type of modulation used in that upstream channel. Similar to operations performed in block 506, this message may include an identifier for the upstream channel being addressed and a message type such as “recover.” A new message type and/or format may need to be defined to support this communication.

In block 528, the processing system 404 may perform operations including receiving a DBC-REQ message from the CMTS 106 indicating that the identified upstream channel is reassigned, bonded or otherwise available for use, or that a higher modulation should be used in the case of an OFDMA channel. This message may be structured according to the DBC messaging format of the DOCSIS protocol.

In block 530, the processing system 404 may perform operations including sending a DBC-RSP message to the CMTS 106 acknowledging that the identified upstream channel is no longer impaired. The processing system 404 may also receive a DBC-ACK message from the CMTS confirming receipt of the DBC-RSP message.

In block 532, the processing system 404 may perform operations including resuming use of the identified upstream channel in transmissions to the CMTS 106. Per the DOCSIS protocol, this may include sending a message requesting an opportunity to send upstream data and requests to the CMTS 106 via the recovered upstream channel and then completing the communications in response to receiving a grant to do so from the CMTS 106.

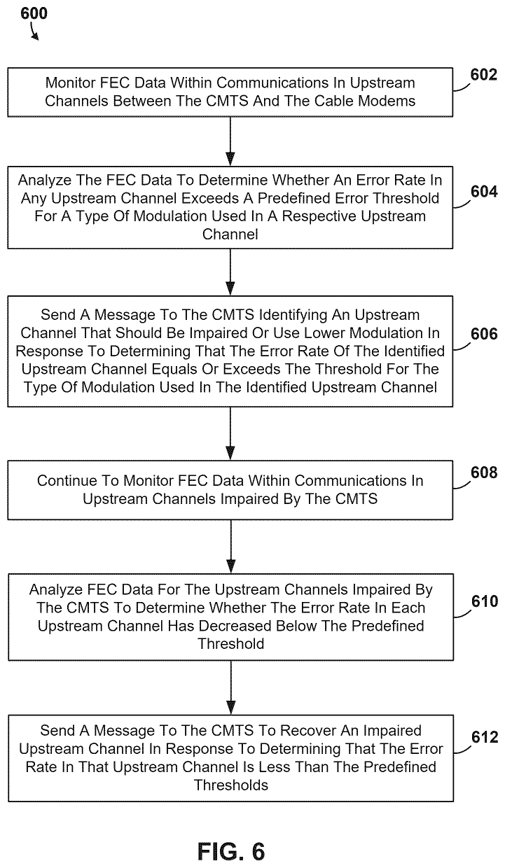

FIG. 6 is a process flow diagram illustrating a method 500 for an external system (i.e., network element 102a external to the CMTS) to inform a CMTS (e.g., 106) when an upstream channel should be impaired or recovered in accordance with some embodiments. With reference to FIGS. 1A-6, the method 600 may be performed in a network element (e.g., 102a) by a processing system (e.g., 422) encompassing one or more components or subsystems discussed in this application. Means for performing the functions of the operations in method 600 may include a processing system including one or more processors and other components within a network element described herein. Further, one or more processors of the network element may be configured with software or firmware (e.g., modules 428-432) to perform some or all of the operations of the method 600. To encompass the alternative configurations enabled in various embodiments, the hardware implementing any or all of the method 600 is referred to herein as a “processing system.”

In block 602, the processing system may perform operations including monitoring forward error correction (FEC) data within communications in upstream channels between the CMTS and the cable modems. In some embodiments, the processing system may execute a FEC data access module 428 to obtain the FEC data or other error rate statistics. As noted above, the external system may be located in a variety of network elements within the cable service network, such as in a network management system element, within a server within the network management system or multiple system operator (MSO) premises, or in a standalone server (or similar computing device) positioned within (i.e., connected to) the back office network 104. Depending upon its location and connections within the cable service network, the external system may have direct access to FEC codeword data, FEC codeword statistics, error correction statistics, or uncorrectable packet statistics, or may request such data from a network element (e.g., the CMTS). For example, the external system may be implemented within, have direct access to data maintained by, or be configured to query a network poller, which is a network function or system component that is responsible for periodically querying devices or systems on the network to gather status information, performance data, or specific metrics. In some embodiments, a new message type and/or format may need to be defined to support this communication.

In block 604, the processing system may perform operations including analyzing, by the network element, the FEC data to determine whether an error rate in any upstream channel exceeds a predefined error threshold corresponding to a type of modulation used in a respective upstream channel. Similar to the operations that may be performed by a cable modem in block 504, processing system of the external system may execute a FEC data analysis module 430 to select the appropriate unacceptable uncorrectable error rate threshold corresponding to the type of modulation used by the associated upstream channel and compare the received FEC data or other error rate statistics to the selected threshold to determine whether the unacceptable error rate meets or exceeds that threshold. Such operations may be performed by the processing system for each upstream channel bonded to each cable modem by the CMTS.

In block 606, the processing system may perform operations including sending a message to the CMTS identifying an upstream channel that should be impaired or use lower modulation (in the case of an OFDMA channel) in response to determining that the error rate of the identified upstream channel equals or exceeds the predefined error rate threshold corresponding to the type of modulation used in the identified upstream channel. As the external system may be positioned in a variety of locations within the back office network 104, this message may be sent using different processes and protocols depending upon the command connections to the CMTS. In some embodiments, a new message type and/or format may need to be defined to support this communication.

In block 608, the processing system may perform operations including continuing to monitor FEC data within communications in upstream channels impaired by the CMTS or using lowered modulation. In some embodiments, this monitoring may involve access to or requests for FEC data or other error rate statistics specifically for impaired upstream channels using data connections or messaging processes similar to those described with reference to block 602. In some embodiments, this monitoring may be accomplished by the operations in block 602 as described, in which case a separate operation may not be involved.

In block 610, the processing system may perform operations including analyzing FEC data or other error rate statistics for the upstream channels that have been impaired by the CMTS to determine whether the error rate in each upstream channel has decreased below the predefined error threshold. The processing system may accomplish this using processes similar to those described with reference to block 604. The processing system may perform the operations in block 610 for each impaired upstream channel managed by the CMTS.

In block 612, the processing system may perform operations including sending a message to the CMTS to recover an impaired upstream channel, or raising channel modulation in the case of and OFDMA channel, in response to determining that the error rate in that upstream channel is less than the predefined error threshold. Similar to the message sent in block 606, this message may be sent using different processes and protocols depending on the command connections to the CMTS. In some embodiments, a new message type and/or format may need to be defined to support this communication.

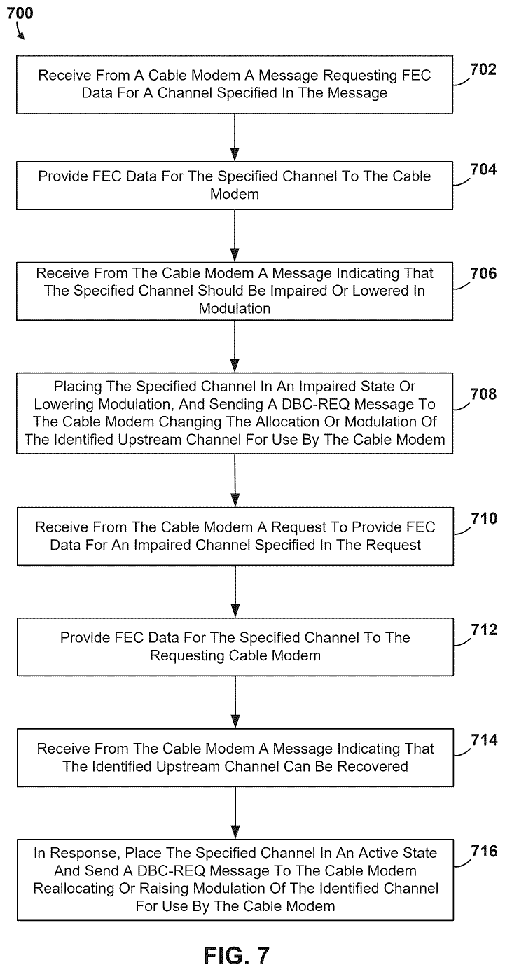

FIG. 7 is a process flow diagram illustrating a method 700 of operations that may be performed by a CMTS in response to upstream channel monitoring messages from a cable modem in accordance with some embodiments. With reference to FIGS. 1A-7, the method 700 may be performed in a CMTS (e.g., 106) by a processing system encompassing one or more components or subsystems discussed in this application. Means for performing the functions of the operations in method 700 may include a processing system including one or more processors and other components within a CMTS described herein. Further, one or more processors of a CMTS may be configured with software or firmware to perform some or all of the operations of method 700. To encompass the alternative configurations enabled in various embodiments, the hardware implementing any or all of the method 700 is referred to herein as a “processing system.”

In block 702, the processing system may perform operations including receiving from a cable modem a message requesting FEC data or other error rate statistics or information for one or more channels identified in the message. In some embodiments, the received request may identify, or otherwise request FEC data for all upstream channels assigned or bonded to the cable modem.

In block 704, the processing system may perform operations including providing FEC data for the identified upstream channel(s) to the cable modem in response to receiving the request in block 702. The processing system may access FEC data, FEC codewords, or other error rate information stored in memory of the CMTS and provide the requested information in a message sent back to the cable modem. A new message type and/or format may need to be defined to support this communication.

In block 706, the processing system may perform operations including receiving from the cable modem 116 a message identifying an upstream channel that should be impaired, or lowered in modulation in the case of an OFDMA channel. As described, the received message may be a new type that includes the upstream channel ID and a message type, such as “impair.”

In block 708, the processing system may perform operations including placing the identified upstream channel in an impaired state or lowering modulation in the case of an OFDMA channel, and sending a DBC-REQ message to the cable modem 116 changing the allocation or modulation of the identified upstream channel for use by the cable modem 116 in response to the message received in block 704 indicating that the identified upstream channel should be impaired or lowered in modulation. In the case of OFDMA channels, if the identified upstream channel is already at the lowest modulation, the DBC-REQ may instruct the cable modem to take actions to impair the identified channel (i.e., remove it from the bonded upstream channels).

In block 710, the processing system may perform operations including receiving from the cable modem 116 a request to provide FEC data for an impaired upstream channel specified in the request. In some embodiments, this message may be part of periodic messages received from the cable modem 116 in block 702 as described.

In block 712, the processing system may perform operations including providing the requested FEC data or other error rate information for the identified upstream channel to the requesting cable modem 116. Similar to the messages sent in block 704, a new message type and/or format may need to be defined to support this communication.

In block 714, the processing system may perform operations including receiving from the cable modem 116 a message indicating that the identified upstream channel can be recovered or raised in modulation in the case of an OFDMA channel. Similar to the message received in block 706, the received message may be a new type that includes the upstream channel ID and a message type, such as “recover.”

In block 716, the processing system may perform operations including placing the identified upstream channel in an active state or raising the modulation of an OFDMA channel, and sending a DBC-REQ message to the cable modem recovering, reallocating, or raising the modulation of the identified upstream channel for use by the cable modem in response to receiving the message indicating that the identified upstream channel may be recovered or raised in modulation. The processing system may thereafter provide the cable modem with communication grants for the identified upstream channel in response to subsequent communication requests from the cable modem 116.

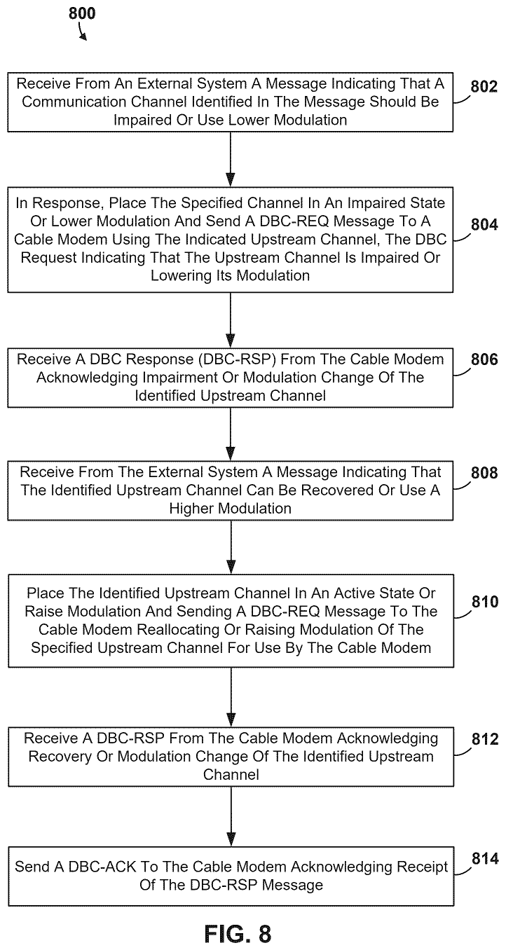

FIG. 8 is a process flow diagram illustrating a method 800 of operations that may be performed by a CMTS in response to upstream channel monitoring messages from a network element separate from the CMTS (“externals system”) in accordance with some embodiments. With reference to FIGS. 1A-8, the method 800 may be performed in a CMTS (e.g., 106) by a processing system encompassing one or more components or subsystems discussed in this application. Means for performing the functions of the operations in method 800 may include a processing system including one or more processors and other components within a CMTS described herein. Further, one or more processors of a CMTS may be configured with software or firmware to perform some or all of the operations of method 800. To encompass the alternative configurations enabled in various embodiments, the hardware implementing any or all of the method 800 is referred to herein as a “processing system.”

In block 802, the processing system may perform operations including receiving from the external system a message indicating that a communication channel identified in the message should be impaired or use lower modulation in the case of an OFDMA channel. In some embodiments, the processing system may receive a command to impair an identified upstream channel directly from the external system. In some embodiments, the processing system may receive a message via a data connection or the back office network including an ID of an upstream channel and a type of action required, such as “impair.” In some embodiments, a new message type and/or format may need to be defined to support this communication.

In response to receiving the message from the external system, in block 804 the processing system may perform operations including placing the identified upstream channel in an impaired state or lowering modulation and sending a DBC-REQ message to a cable modem that is assigned and using the indicated upstream channel. The DBC-REQ message may identify the upstream channel and inform the cable modem that the upstream channel is impaired (i.e., will no longer be available for use) or lowering the modulation used in an OFDMA channel. In the case of an OFDMA channel, if the identified upstream channel is already using the lowest modulation, the DBC-REQ may instruct the cable modem to take actions to impair the identified channel (i.e., remove it from the bonded upstream channels).

In block 806, the processing system may perform operations including receiving a DBC-RSP message from the cable modem acknowledging impairment or modulation change of the identified upstream channel.

In block 808, the processing system may perform operations including receiving from the external system a message indicating that the identified upstream channel can be recovered or use a higher modulation.

In block 810, the processing system may perform operations including placing the identified upstream channel in an active state or using a higher modulation and sending a DBC-REQ message to the cable modem recovering, reallocating raising the modulation of the identified upstream channel for use by the cable modem in response to receiving the message indicating that the specified upstream channel can be recovered or use a higher modulation.

In block 812, the processing system may perform operations including receiving a DBC-RSP from the cable modem acknowledging recovery or modulation change of the identified upstream channel, and providing the cable modem with communication grants for the identified upstream channel in response to subsequent communication requests from the cable modem.

In block 814, the processing system may perform operations including sending a DBC-ACK message to the cable modem acknowledging receipt of the DBC-RSP.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the other methods, and vice versa.

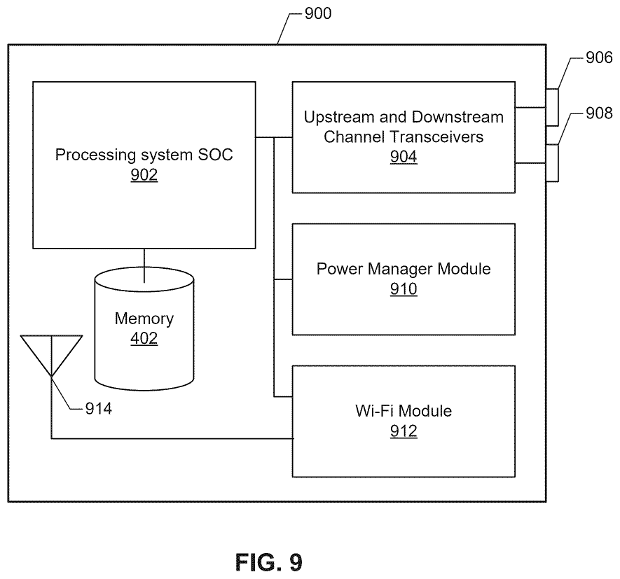

Various embodiments (including, but not limited to, embodiments discussed above with reference to FIGS. 1A-6) may be implemented on any of a variety of cable modems 900 an example of which is illustrated in FIG. 9. Such a cable modem 900 may include a processing system SoC 902 coupled to memory 402, upstream and downstream transceivers 904, a power manager module 910, and, in some cable modems, a Wi-Fi module 912 coupled to a wireless antenna 914.

The processing system SoC 902 may include a processing system of one or more processors configured to perform the basic operations of the cable modem, including operations of various embodiments, such as described with reference to FIGS. 5A and 5B.

The memory 402 stores the software, firmware and operational data required for the cable modem to function, including performing operations of various embodiments described herein. The memory 402 also stores temporary data related to FEC statistics and other performance metrics. The memory 402 may be used to store threshold values (e.g., unacceptable uncorrectable error rate thresholds for various modulation schemes used in upstream channels, historical FEC data, and information related to upstream channel assignments. The memory 402 may also hold the logic and firmware needed to run the algorithms for monitoring and decision-making.

The one or more upstream and downstream channel transceivers 904 perform operations of receiving incoming (i.e., downstream communication) electrical signals from connected communication network (e.g., the HFC network 110) and translating the signals into digital data that can be processed by the processing system SOC 902, as well as translating digital data from the processing system SOC 902 to be transmitted (i.e., upstream communications) into electrical signals that are transmitted over a connected communication network (e.g., the HFC network 110). In some embodiments, one or more of the upstream and downstream channel transceivers 904 may also perform transceiving operations for communicating data via the home network.

The one or more upstream and downstream channel transceivers 904 may be electronically coupled to network connectors, such as a network connector 906 for connecting to an external network, such as the HFC network 110, and a local area network connector 908 for connecting to a wired home network.

The power manager module 906 ensures efficient power delivery to all components and handles power-related operations like resets or adjustments to operational modes. While not directly involved in FEC data monitoring, power management ensures the continuous operation of the modem and its components, critical for maintaining accurate, uninterrupted FEC data analysis.

In cable modems that support Wi-Fi network communications, the Wi-Fi module 912 includes the transceiver and radio for providing Wi-Fi communication links with various computing devices within the home network. The Wi-Fi module 912 may be configured to receive data to be transmitted from the processing system SOC 902, packetizing the data for transmission according to Wi-Fi protocols, translating the packetized data into wireless signal, and transmitting the signals via the antennal 914. The Wi-Fi module 912 may also be configured to receive WiFi wireless signals from the antennal 914, translate the received wireless signals into digital format, extract digital data from Wi-Fi packets, and provide the digital data to the processing system SOC 902.

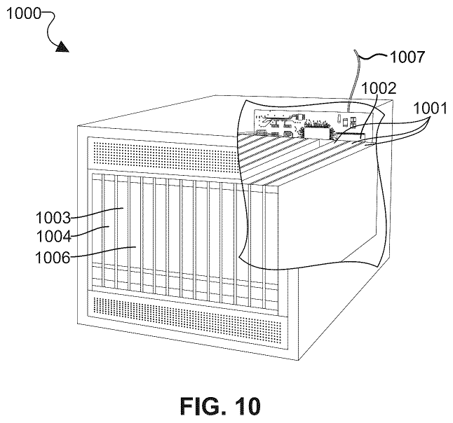

Various embodiments (including, but not limited to, embodiments discussed above with reference to FIGS. 1A-8) may be implemented on any of a variety of commercially available network computing devices, such as a commercially available server 1000, an example of which is illustrated in FIG. 10. Such a server 1000 may be configured with software to perform the functions of the external system of some embodiments. Additionally, a server 1000 may be configured with software to execute CMTS functions compliant with the DOCSIS protocol, as well as additional functionality of various embodiments described herein. Such a server 1000 may include a processor 1001 coupled to volatile memory 1002 and a large capacity nonvolatile memory, such as a disk drive 1003. The server 1000 may also include a floppy disc drive 1004, USB, compact disc (CD) or DVD disc drive coupled to the processor 1001. The server 1000 may also include network access ports 1007 coupled to the processor 1001 for establishing data connections with network connection circuits 1006 and communication networks, including back office networks (e.g., 104), HFC networks (e.g., 110), and other communication system network elements.

Implementation examples are described in the following paragraphs. While some of the following implementation examples are described in terms of example methods, further example implementations may include: the example methods discussed in the following paragraphs implemented in a cable modem, CMTS computing device, or a network computing device including a processing system configured with processor-executable instructions to perform operations of the methods of the following implementation examples; and the example methods discussed in the following paragraphs implemented as a non-transitory processor-readable storage medium having stored thereon processor-executable instructions configured to cause a processing system to perform operations of the methods of the following implementation examples.

Example 1. A method performed by a cable modem for monitoring error rates in upstream communication channels communicating with a Cable Modem Termination System (CMTS), including: periodically sending, by the cable modem, a request to the CMTS for forward error correction (FEC) data for communications in assigned upstream channels; analyzing, by the cable modem, the FEC data to determine whether an error rate in any assigned upstream channel exceeds a predefined error rate threshold corresponding to a type of modulation used in a respective assigned upstream channel; and sending, by the cable modem, a message to the CMTS identifying an upstream channel that should be impaired or lowered in modulation in response to determining that the error rate of an identified upstream channel equals or exceeds the corresponding predefined error rate threshold.

Example 2. The method of example 1, wherein the message sent by the cable modem to the CMTS identifying the upstream channel that should be impaired or lowered in modulation is a traffic management message that includes an identifier of the upstream channel and an identifier of an impairment event type.

Example 3. The method of either of examples 1 or 2, further including: receiving by the cable modem from the CMTS a dynamic bonding change request (DBC-REQ) message indicating that the identified upstream channel is impaired or lowered in modulation; and sending, by the cable modem, a message to the CMTS acknowledging that the identified upstream channel is impaired; and suspending use of the identified upstream channel in transmissions to the CMTS.

Example 4. The method of any of examples 1-3, further including: continuing to send requests from the cable modem to the CMTS for FEC data from the CMTS for an assigned upstream channel that is impaired by the CMTS; analyzing, by the cable modem, FEC data received from the CMTS for the assigned upstream channel that is impaired by the CMTS to determine whether the error rate in that assigned upstream channel has decreased below the predefined error rate threshold for the type of modulation used in that upstream channel; and sending, by the cable modem, a message to the CMTS to recover the impaired or use higher modulation for assigned upstream channel in response to determining that the error rate is less than the predefined error rate threshold for the type of modulation used in that assigned channel.

Example 5. The method of any of examples 1-4, wherein the message sent by the cable modem to the CMTS to recover the impaired assigned upstream channel is a traffic management message that includes an identifier of the impaired assigned upstream channel and an identifier of a recovery event type.

Example 6. The method of any of examples 1-4, further including: receiving by the cable modem from the CMTS a dynamic bonding change request (DBC-REQ) message indicating that the identified assigned upstream channel is available for use or raising channel modulation; sending, by the cable modem, a DBC response (DBC-RSP) message to the CMTS acknowledging that the identified assigned upstream channel is no longer impaired or that the modulation is raised; and resuming use of the identified assigned upstream channel in transmissions to the CMTS.

Example 7. The method of any of examples 1-6, wherein the requests sent by the cable modem to the CMTS for FEC data are management traffic messages that include a channel identifier (ID) and a type of data requested.

Example 8. The method of any of examples 1-7, further including receiving, by the cable modem, a bonding change request (BCR) message from the CMTS indicating an updated status of the identified assigned upstream channel.

Example 9. The method of any of examples 1-8, wherein the predetermined error threshold for the type of modulation used in each upstream channel is selected by the cable modem from a plurality of predetermined thresholds corresponding to types of modulation used in upstream channels.

Example 10. A method performed in a cable modem termination system (CMTS), including: receiving from a cable modem a message requesting forward error correction (FEC) data for an upstream channel identified in the message; providing FEC data for the identified upstream channel to the cable modem; receiving from the cable modem a message identifying an upstream channel that should be impaired or lowered in modulation; and placing the identified upstream channel in an impaired state or lowering modulation of the channel and sending a dynamic bonding change (DBC) request (DBC-REQ) message to the cable modem changing the allocation or the modulation of the identified upstream channel for use by the cable modem in response to receiving the message indicating that the identified upstream channel should be impaired or lowered in modulation.

Example 11. The method of example 10, further including: receiving from the cable modem a request to provide FEC data for an impaired upstream channel specified in the request; providing FEC data for the identified upstream channel to the requesting cable modem; receiving from the cable modem a message indicating that the identified upstream channel can be recovered or use a higher modulation; and placing the identified upstream channel in an active state and sending a DBC-REQ message to the cable modem reallocating or raising modulation of the identified upstream channel for use by the cable modem in response to receiving the message indicating that the identified upstream channel can be recovered or use a higher modulation.

Example 12. A method performed by a network element separate from a Cable Modem Termination System (CMTS) for monitoring upstream channels for communications between the CMTS and cable modems, including: monitoring, by the network element, forward error correction (FEC) data within communications in upstream channels between the CMTS and the cable modems; analyzing, by the network element, the FEC data to determine whether an error rate in any upstream channel exceeds a predefined error threshold corresponding to a type of modulation used in a respective upstream channel; sending, by the network element, a message to the CMTS identifying an upstream channel that should be impaired or use lower modulation in response to determining that the error rate of the identified upstream channel equals or exceeds the predefined error threshold for the type of modulation used in the identified upstream channel.

Example 13. The method of example 12, wherein the message sent by the network element to the CMTS identifying an upstream channel that should be impaired or use lower modulation includes an identifier of the upstream channel and an identifier of an impairment event type.

Example 14. The method of either of example 12 or 13, further including: continuing to monitor, by the network element, FEC data within communications in upstream channels impaired by the CMTS; analyzing, by the network element, FEC data for the upstream channels impaired or using lowered modulation by the CMTS to determine whether the error rate in each upstream channel has decreased below the corresponding predefined error rate threshold; and sending, by the network element, a message to the CMTS to recover an impaired upstream channel or use higher modulation for upstream channel in response to determining that the error rate in that upstream channel is less than the predefined error rate thresholds.

Example 15. The method of example 14, wherein the message sent by the network element to the CMTS to recover the impaired upstream channel is a traffic management message that includes an identifier of the impaired upstream channel and an identifier of a recovery event type.

Example 16. The method of any of examples 12-14, wherein the predetermined error threshold is selected by the network element for each monitored upstream channel based on a modulation of the upstream channel from a plurality of predetermined thresholds corresponding to types of modulation used in upstream channels.

Example 17. A method performed in a cable modem termination system (CMTS), including: receiving from an external system a message indicating that a communication channel identified in the message should be impaired or lowered in modulation; in response to receiving the message from the external system, placing the identified upstream channel in an impaired state and sending a dynamic bonding change (DBC) request (DBC-REQ) message to a cable modem using the identified upstream channel, the DBC request indicating that the upstream channel is impaired or lowering modulation of the channel; and receiving a DBC response (DBC-RSP) from the cable modem acknowledging impairment or lowering of modulation of the identified upstream channel.

Example 18. The method of example 17, further including: receiving from the external system a message indicating that the identified upstream channel can be recovered or higher modulation can be used; placing the specified upstream channel in an active state or raising the modulation of the channel and sending a DBC-REQ message to the cable modem reallocating the identified upstream channel for upstream communication use by the cable modem in response to receiving the message indicating that the specified upstream channel can be recovered; and receiving a DBC response (DBC-RSP) from the cable modem acknowledging availability or raised modulation of the identified upstream channel.

The processors discussed in this application may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors. The processors may include internal memory sufficient to store the application software instructions. In many devices, the internal memory may be a volatile or nonvolatile memory, such as flash memory, or a mixture of both. For the purposes of this description, a general reference to memory refers to memory accessible by the processors including internal memory or removable memory plugged into the device and memory within the processors themselves. Additionally, as used herein, any reference to a memory may be a reference to a memory storage and the terms may be used interchangeable.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method performed by a cable modem for monitoring error rates in upstream communication channels communicating with a Cable Modem Termination System (CMTS), comprising:
periodically sending, by the cable modem, a request to the CMTS for forward error correction (FEC) data for communications in assigned upstream channels;
analyzing, by the cable modem, the FEC data to determine whether an error rate in any assigned upstream channel exceeds a predefined error rate threshold corresponding to a type of modulation used in a respective assigned upstream channel; and
sending, by the cable modem, a message to the CMTS identifying an upstream channel that should be impaired or lowered in modulation in response to determining that the error rate of an identified upstream channel equals or exceeds the corresponding predefined error rate threshold.

2. The method of claim 1, wherein the message sent by the cable modem to the CMTS identifying the upstream channel that should be impaired or lowered in modulation is a traffic management message that includes an identifier of the upstream channel and an identifier of an impairment event type.

3. The method of claim 1, further comprising:
receiving by the cable modem from the CMTS a dynamic bonding change request (DBC-REQ) message indicating that the identified upstream channel is impaired or lowered in modulation; and
sending, by the cable modem, a message to the CMTS acknowledging that the identified upstream channel is impaired; and
suspending use of the identified upstream channel in transmissions to the CMTS.

4. The method of claim 1, further comprising:
continuing to send requests from the cable modem to the CMTS for FEC data from the CMTS for an assigned upstream channel that is impaired by the CMTS;
analyzing, by the cable modem, FEC data received from the CMTS for the assigned upstream channel that is impaired by the CMTS to determine whether the error rate in that assigned upstream channel has decreased below the predefined error rate threshold for the type of modulation used in that upstream channel; and
sending, by the cable modem, a message to the CMTS to recover the impaired or use higher modulation for assigned upstream channel in response to determining that the error rate is less than the predefined error rate threshold for the type of modulation used in that assigned channel.

5. The method of claim 4, wherein the message sent by the cable modem to the CMTS to recover the impaired assigned upstream channel is a traffic management message that includes an identifier of the impaired assigned upstream channel and an identifier of a recovery event type.

6. The method of claim 4, further comprising:
receiving by the cable modem from the CMTS a dynamic bonding change request (DBC-REQ) message indicating that the identified assigned upstream channel is available for use or raising channel modulation;
sending, by the cable modem, a DBC response (DBC-RSP) message to the CMTS acknowledging that the identified assigned upstream channel is no longer impaired or that the modulation is raised; and
resuming use of the identified assigned upstream channel in transmissions to the CMTS.

7. The method of claim 1, wherein the requests sent by the cable modem to the CMTS for FEC data are management traffic messages that include a channel identifier (ID) and a type of data requested.

8. The method of claim 1, further comprising receiving, by the cable modem, a bonding change request (BCR) message from the CMTS indicating an updated status of the identified assigned upstream channel.

9. The method of claim 1, wherein the predetermined error threshold for the type of modulation used in each upstream channel is selected by the cable modem from a plurality of predetermined thresholds corresponding to types of modulation used in upstream channels.

10. A method performed in a cable modem termination system (CMTS), comprising:
receiving from a cable modem a message requesting forward error correction (FEC) data for an upstream channel identified in the message;
providing FEC data for the identified upstream channel to the cable modem;
receiving from the cable modem a message identifying an upstream channel that should be impaired or lowered in modulation; and
placing the identified upstream channel in an impaired state or lowering modulation of the channel and sending a dynamic bonding change (DBC) request (DBC-REQ) message to the cable modem changing the allocation or the modulation of the identified upstream channel for use by the cable modem in response to receiving the message indicating that the identified upstream channel should be impaired or lowered in modulation.

11. The method of claim 10, further comprising:
receiving from the cable modem a request to provide FEC data for an impaired upstream channel specified in the request;
providing FEC data for the identified upstream channel to the requesting cable modem;
receiving from the cable modem a message indicating that the identified upstream channel can be recovered or use a higher modulation; and
placing the identified upstream channel in an active state and sending a DBC-REQ message to the cable modem reallocating or raising modulation of the identified upstream channel for use by the cable modem in response to receiving the message indicating that the identified upstream channel can be recovered or use a higher modulation.

12. A method performed by a network element separate from a Cable Modem Termination System (CMTS) for monitoring upstream channels for communications between the CMTS and cable modems, comprising:
monitoring, by the network element, forward error correction (FEC) data within communications in upstream channels between the CMTS and the cable modems;
analyzing, by the network element, the FEC data to determine whether an error rate in any upstream channel exceeds a predefined error threshold corresponding to a type of modulation used in a respective upstream channel;
sending, by the network element, a message to the CMTS identifying an upstream channel that should be impaired or use lower modulation in response to determining that the error rate of the identified upstream channel equals or exceeds the predefined error threshold for the type of modulation used in the identified upstream channel.

13. The method of claim 12, wherein the message sent by the network element to the CMTS identifying an upstream channel that should be impaired or use lower modulation includes an identifier of the upstream channel and an identifier of an impairment event type.

14. The method of claim 12, further comprising:
continuing to monitor, by the network element, FEC data within communications in upstream channels impaired by the CMTS;
analyzing, by the network element, FEC data for the upstream channels impaired or using lowered modulation by the CMTS to determine whether the error rate in each upstream channel has decreased below the corresponding predefined error rate threshold; and
sending, by the network element, a message to the CMTS to recover an impaired upstream channel or use higher modulation for upstream channel in response to determining that the error rate in that upstream channel is less than the predefined error rate thresholds.

15. The method of claim 14, wherein the message sent by the network element to the CMTS to recover the impaired upstream channel is a traffic management message that includes an identifier of the impaired upstream channel and an identifier of a recovery event type.

16. The method of claim 12, wherein the predetermined error threshold is selected by the network element for each monitored upstream channel based on a modulation of the upstream channel from a plurality of predetermined thresholds corresponding to types of modulation used in upstream channels.

17. A method performed in a cable modem termination system (CMTS), comprising:
receiving from an external system a message indicating that a communication channel identified in the message should be impaired or lowered in modulation;
in response to receiving the message from the external system, placing the identified upstream channel in an impaired state and sending a dynamic bonding change (DBC) request (DBC-REQ) message to a cable modem using the identified upstream channel, the DBC request indicating that the upstream channel is impaired or lowering modulation of the channel; and
receiving a DBC response (DBC-RSP) from the cable modem acknowledging impairment or lowering of modulation of the identified upstream channel.

18. The method of claim 17, further comprising:
receiving from the external system a message indicating that the identified upstream channel can be recovered or higher modulation can be used;
placing the specified upstream channel in an active state or raising the modulation of the channel and sending a DBC-REQ message to the cable modem reallocating the identified upstream channel for upstream communication use by the cable modem in response to receiving the message indicating that the specified upstream channel can be recovered; and
receiving a DBC response (DBC-RSP) from the cable modem acknowledging availability or raised modulation of the identified upstream channel.

19. A cable modem, comprising:
a memory;
one or more network transceivers; and
a processing system coupled to the memory and one or more network transceiver and configured to perform operations comprising:
periodically sending a request to a Cable Modem Termination System (CMTS) the CMTS for forward error correction (FEC) data for communications in assigned upstream channels;
analyzing the FEC data to determine whether an error rate in any assigned upstream channel exceeds a predefined error rate threshold corresponding to a type of modulation used in a respective assigned upstream channel; and
sending a message to the CMTS identifying an upstream channel that should be impaired or lowered in modulation in response to determining that the error rate of an identified upstream channel equals or exceeds the corresponding predefined error rate threshold.

20. The cable modem of claim 19, wherein the processing system is configured such that the message sent to the CMTS identifying the upstream channel that should be impaired or lowered in modulation is a traffic management message that includes an identifier of the upstream channel and an identifier of an impairment event type.

21. The cable modem of claim 19, wherein the processing system is configured to perform operations further comprising:
receiving from the CMTS a dynamic bonding change request (DBC-REQ) message indicating that the identified upstream channel is impaired or lowered in modulation; and
sending a message to the CMTS acknowledging that the identified upstream channel is impaired; and
suspending use of the identified upstream channel in transmissions to the CMTS.

22. The cable modem of claim 19, wherein the processing system is configured to perform operations further comprising:
continuing to send requests to the CMTS for FEC data from the CMTS for an assigned upstream channel that is impaired by the CMTS;
analyzing FEC data received from the CMTS for the assigned upstream channel that is impaired by the CMTS to determine whether the error rate in that assigned upstream channel has decreased below the predefined error rate threshold for the type of modulation used in that upstream channel; and
sending a message to the CMTS to recover the impaired or use higher modulation for assigned upstream channel in response to determining that the error rate is less than the predefined error rate threshold for the type of modulation used in that assigned channel.

23. The cable modem of claim 22, wherein the processing system is configured to perform operations such that the message sent to the CMTS to recover the impaired assigned upstream channel is a traffic management message that includes an identifier of the impaired assigned upstream channel and an identifier of a recovery event type.

24. The cable modem of claim 22, wherein the processing system is configured to perform operations further comprising:
receiving from the CMTS a dynamic bonding change request (DBC-REQ) message indicating that the identified assigned upstream channel is available for use or raising channel modulation;
sending a DBC response (DBC-RSP) message to the CMTS acknowledging that the identified assigned upstream channel is no longer impaired or that the modulation is raised; and
resuming use of the identified assigned upstream channel in transmissions to the CMTS.

25. The cable modem of claim 19, wherein the processing system is configured such that the requests sent to the CMTS for FEC data are management traffic messages that include a channel identifier (ID) and a type of data requested.

26. The cable modem of claim 19, wherein the processing system is configured to perform operations further comprising receiving a bonding change request (BCR) message from the CMTS indicating an updated status of the identified assigned upstream channel.

27. The cable modem of claim 19, wherein the processing system is configured to perform operations comprising selecting from the memory the predetermined error threshold for the type of modulation used in each upstream channel from a plurality of predetermined thresholds corresponding to types of modulation used in upstream channels.

28. A cable modem termination system (CMTS), comprising:
a memory;
one or more network transceivers; and
a processing system coupled to the memory and one or more network transceiver and configured to perform operations comprising:
receiving from a cable modem a message requesting forward error correction (FEC) data for an upstream channel identified in the message;
providing FEC data for the identified upstream channel to the cable modem;
receiving from the cable modem a message identifying an upstream channel that should be impaired or lowered in modulation; and
placing the identified upstream channel in an impaired state or lowering modulation of the channel and sending a dynamic bonding change (DBC) request (DBC-REQ) message to the cable modem changing the allocation or the modulation of the identified upstream channel for use by the cable modem in response to receiving the message indicating that the identified upstream channel should be impaired or lowered in modulation.

29. The CMTS of claim 28, wherein the processing system is configured to perform operations further comprising:
receiving from the cable modem a request to provide FEC data for an impaired upstream channel identified in the request;
providing FEC data for the identified upstream channel to the requesting cable modem;
receiving from the cable modem a message indicating that the identified upstream channel can be recovered or use a higher modulation; and
placing the identified upstream channel in an active state and sending a DBC-REQ message to the cable modem reallocating or raising modulation of the identified upstream channel for use by the cable modem in response to receiving the message indicating that the identified upstream channel can be recovered or use a higher modulation.

30. A computing device configured to function as a network element in a cable services network, comprising:
a memory;
one or more network transceivers; and
a processing system coupled to the memory and one or more network transceiver and configured to perform operations comprising:
monitoring forward error correction (FEC) data within communications in upstream channels between a Cable Modem Termination System (CMTS) and cable modems;
analyzing the FEC data to determine whether an error rate in any upstream channel exceeds a predefined error threshold corresponding to a type of modulation used in a respective upstream channel;
sending a message to the CMTS identifying an upstream channel that should be impaired or use lower modulation in response to determining that the error rate of the identified upstream channel equals or exceeds the predefined error threshold for the type of modulation used in the identified upstream channel.

31. The computing device of claim 30, wherein the processing system is configured to perform operations such that the message sent by the network element to the CMTS identifying an upstream channel that should be impaired or use lower modulation includes an identifier of the upstream channel and an identifier of an impairment event type.

32. The computing device of claim 30, wherein the processing system is configured to perform operations further comprising:
continuing to monitor FEC data within communications in upstream channels impaired by the CMTS;
analyzing FEC data for the upstream channels impaired or using lowered modulation by the CMTS to determine whether the error rate in each upstream channel has decreased below the corresponding predefined error rate threshold; and
sending a message to the CMTS to recover an impaired upstream channel or use higher modulation for the upstream channel in response to determining that the error rate in that upstream channel is less than the predefined error rate thresholds.

33. The computing device of claim 32, wherein the processing system is configured to perform operations such that the message sent to the CMTS to recover the impaired upstream channel is a traffic management message that includes an identifier of the impaired upstream channel and an identifier of a recovery event type.

34. The computing device of claim 30, wherein the processing system is configured to perform operations further comprising selecting from the memory the predetermined error threshold for each monitored upstream channel based on a modulation of the upstream channel from a plurality of predetermined thresholds corresponding to types of modulation used in upstream channels.

35. A cable modem termination system (CMTS), comprising:
a memory;
one or more network transceivers; and
a processing system coupled to the memory and one or more network transceiver and configured to perform operations comprising:
receiving from an external system a message indicating that a communication channel identified in the message should be impaired or lowered in modulation;
in response to receiving the message from the external system, placing the identified upstream channel in an impaired state and sending a dynamic bonding change (DBC) request (DBC-REQ) message to a cable modem using the identified upstream channel, the DBC request indicating that the upstream channel is impaired or lowering modulation of the channel; and
receiving a DBC response (DBC-RSP) from the cable modem acknowledging impairment or lowering modulation of the identified upstream channel.

36. The CMTS of claim 35, wherein the processing system is configured to perform operations further comprising:
receiving from the external system a message indicating that the identified upstream channel can be recovered or higher modulation can be used;
placing the identified upstream channel in an active state or raising the modulation of the channel and sending a DBC-REQ message to the cable modem reallocating the identified upstream channel for upstream communication use by the cable modem in response to receiving the message indicating that the identified upstream channel can be recovered; and
receiving a DBC response (DBC-RSP) from the cable modem acknowledging availability or raised modulation of the identified upstream channel.
